(19) United States
(12) Patent Application Publication
(10) Pub. No.: US 2007/0130190 A1
(43) Pub. Date: Jun. 7, 2007

(54) Data storage device, information transmitter, data storage system and information processing system

(75) Inventor: Tadashi Yoshikawa, Tochigi (JP)

Correspondence Address: BIRCH STEWART KOLASCH & BIRCH, PO BOX 747, FALLS CHURCH, VA, 22040-0747, US

(73) Assignee: SHARP KABUSHIKI KAISHA, Osaka (JP)

(21) Appl. No.: 10/583,273

(22) PCT Filed: Jun. 28, 2004
(86) PCT No.: PCT/JP04/09107

§ 371 Date: Jun. 16, 2006

(30) Foreign Application Priority Data
Dec. 19, 2003 (JP) 2003-423735

(51) Int. Cl. G06F 7/00

(52) U.S. Cl. 707/102

(57) ABSTRACT

To provide a data storage device and a data storage system capable of giving an arbitrary name to a folder and a file in each data to be stored in a memory. For example, pieces of code information are corresponded to respective two-dimensional bar codes and stored in a code information DB 14b, and a code recognition unit 14 recognizes a code stored in the code information DB 14b from image data obtained by picking up an image by a camera unit 13a, and a piece of the code information corresponding to the recognized code is extracted from the code information DB 14b. In addition, based on the extracted piece of the code information, a name generation unit 15 generates a folder name or a file of an image file stored in a recording medium 17.

This application is national phase under 35 U.S.C. §371 of PCT International Application No. PCT/JP2004/009107 which has an international filing date of Jun. 28, 2004, and designated the United States of America

### TECHNICAL FIELD

The present invention relates to a data storage device that stores acquired data in a hierarchical structure. In particular, the present invention relates to the data storage device, with an image pickup unit provided therein, that generates names of a file of the data and a folder having each file based on code information in image data obtained by picking up an image at the image pickup unit. The present invention also relates to, with the image pickup unit provided therein, an information transmitter that analyzes a code extracted from the image data obtained by picking up the image at the image pickup unit and transmits code information thus obtained to outside, a data storage system that generates a folder name or a file name of the data stored in the data storage device based on the code information transmitted by the information transmitter, and an information processing system in which an information processor performs a predetermined processing based on the code information transmitted by the information transmitter.

### BACKGRAOUND ART

A digital camera, a digital voice player, a cellular phone, and PDA (Personal Digital Assistants), etc, that record either of or both of image data and voice data in a memory such as a memory card, a magnetic medium, a photomagnetic medium or a semiconductor memory have been in common use. In these devices, each data is stored in the memory as a data file managed for each folder previously set in a hierarchical structure.

In the aforementioned devices, scale-down is in progress to improve a portability of each device. Along with this tendency, there is a limit in the number of operation buttons, and therefore frequently it becomes difficult for a user to freely set a file name and a folder name of each data file to be stored in the memory. Accordingly, each device is designed to automatically set the file name and the folder name of each data file based on an order of storing each data and time and date of acquiring each data, for example (see Patent Document 1, for example).

In addition, some devices are designed to make data communication or wireless communication possible via cable between the devices and a computer. These devices receive the file name or the folder name from the computer, and can prepare the folder of the folder name thus received in the memory, and further can change the file name or the folder name of each data file to the file name or the folder name received from the computer.

Further, in the device in which each data file is stored in the memory which can be removed from a device body such as a memory card, the memory card is removed from the device body, and by using the computer capable of reading this memory card, the folder can be newly prepared in a storage area of the memory card, and the file name and the folder name of each data file already stored in the memory card can be changed.

(Patent Document 1) Japanese Patent No. 3445325

### DISCLOSURE OF THE INVENTION

### Problems to be Solved by the Invention

However, as described above, the file name and the folder name are automatically set by a predetermined processing of each device, and in this case, the name is constituted by using numeral characters and alphabetic characters in many cases, and it is difficult to predict data content in each data file from the file name and the folder name designated by numeral characters and alphabetic characters. Therefore, the content of each data file is required to be confirmed when each data is processed, thus involving a problem that a processing load is increased.

Also, in the device for receiving the file name or the folder name from a computer, an interface is required to be provided for performing a data communication between the devices and the computer and the devices and the computer must be connected every time the file name and the folder name of each data file are changed, thus requiring much labor. Further, when the file name and the folder name are set by using the computer capable of reading the memory card, it is necessary to remove the memory card from each device and mount the memory card thus removed on the computer. In this case also, every time the file name and the folder name of each data file are changed, the memory card is required to be mounted on the computer, thus involving the problem that much labor is required and a portability of a portable-type device is deteriorated.

Meanwhile, when programming timer recording in a recording device for recording a broadcast program by a television broadcast, it is necessary for a user to properly operate each operation button provided in a remote controller for remotely controlling the recording device from a distance, for example, and set a broadcast channel, broadcasting start time, and broadcasting termination time of the broadcast program desired to be recorded. Accordingly, there is a problem that a key operation by the user is complicated.

In view of the above-described circumstances, the present invention is provided, and an object of the present invention is to provide a data storage device capable of extracting code information corresponding to a code from image data obtained by picking up an image including the code, and of generating, based on the code information thus extracted, an arbitrary names of a folder and a file in each data stored in a memory. Also another object of the present invention is to provide the data storage device capable of surely generating the folder name and the file name in each data stored in the memory based on the predetermined information, when the code is not included in the image data obtained by picking up the image.

Further, still another object of the present invention is to provide an information transmitter that analyzes a code acquired from the image data obtained by picking up the image and transmits the code information thus obtained to outside, a data storage system capable of generating arbitrary names of folder and file in the data stored in the data storage device based on the code information transmitted by the information transmitter, and an information processing system in which the information processor performs a predetermined processing based on the code information transmitted by the information transmitter.

### Means for Solving the Problems

A data storage device according to the present invention having a storage means that stores acquired data in a hierarchical structure includes an image pickup unit, an extraction means that extracts a piece of code information from a piece of image data acquired by picking up an image by the image pickup unit, and a name generation means that generates a folder name or a file name relating to the piece of image data based on the piece of code information extracted by the extraction means.

According to the present invention, the extraction means extracts the piece of code information from the piece of image data obtained by picking up the image by the image pickup unit, and based on the piece of code information thus extracted, the name generation means generates the folder name or the file name relating to each data stored in the storage means in a hierarchical structure. Accordingly, for example, the piece of code information is previously corresponded to each code such as a two-dimensional bar code, and the piece of code information corresponding to the code is extracted from the piece of image data obtained by picking up the image of each code, and based on the piece of code information thus extracted, the folder name or the file name is generated.

The data storage device according to the present invention having the storage means that stores the acquired data in a hierarchical structure includes an image pickup unit, a code recognition unit having a table in which pieces of code information is respectively corresponded to a plurality of pieces of image data, an extraction means that extracts a piece of the code information corresponding to a piece of the image data acquired by picking up an image by the image pickup unit, and a name generation means that generates a folder name or a file name relating to the piece of the image data based on the piece of the code information extracted by the extraction means.

According to the present invention, the table in which the piece of the code information is respectively corresponded to the plurality of pieces of the image data is previously prepared, and from the table, the extraction means extracts the pieces of the code information corresponding to the pieces of the image data obtained by picking up the image by the image pickup unit, and based on the pieces of the code information thus extracted, the name generation means generates the folder name or the file name relating to each data stored in the storage means in a hierarchical structure. Accordingly, for example, based on the table wherein the pieces of the code information is previously corresponded to the pieces of the image data of each code such as a two-dimensional bar code, the pieces of the code information corresponding to the pieces of the image data obtained by picking up the image of each code is acquired, and based on the pieces of the code information thus acquired, a desired folder name or file name is generated.

The data storage device according to the present invention includes a determination means that determines whether or not the piece of the code information is extracted by the extraction means, wherein when the determination means determines that the piece of the code information is not extracted by the extraction means, the name generation means generates the folder name or the file name relating to the piece of the image data based on predetermined information.

According to the present invention, the determination means determines whether or not the piece of the code information can be extracted by the extraction means from the piece of the image data obtained by picking up the image by the image pickup unit, and when the determination means determines that the extraction means cannot extract the piece of the code information based on the predetermined information, the name generation means generates the folder name or the file name relating to each data stored in the storage means in a hierarchical structure.

The data storage means according to the present invention has a report means that reports a message that the piece of the code information is not extracted by the extraction means, when the determination means determines accordingly.

According to the present invention, when the determination means determines that the piece of the code information cannot be extracted by the extraction means, the report means reports the message that the piece of the code information cannot be extracted, specifically, an arbitrary name cannot be given to the folder name or the file name relating to each data.

The data storage means according to the present invention includes a folder generation means that generates in the storage means a folder of the folder name generated by the name generation means, and a name changing means that changes the folder name or the file name relating to data stored in the storage means, to the folder name or the file name generated by the name generation means.

According to the present invention, the folder generation means generates the folder of the folder name generated by the name generation means, and the name changing means changes the folder name (or file name) according to the data stored in the storage means, to the folder name (or file name) generated by the name generation means.

The data storage means according to the present invention includes a reception means that receives a selection of a first or second processing, wherein when the reception means receives the selection of the first processing, the folder generation means generates in the storage means the folder of the folder name generated by the name generation means, and when the reception means receives the selection of the second processing, the name changing means changes the folder name or the file name relating to the data stored in the storage means, to the folder name or the file name generated by the name generation means.

According to the present invention, the reception means for receiving the selection of the first processing or the second processing is provided, and when the reception means receives the selection of the first processing, the folder generation means generates in the storage means the folder of the folder name generated by the name generation means. Meanwhile, when the reception means receives the selection of the second processing, the name changing means changes the folder name (or file name) according to the data stored in the storage means, to the folder name (or file name) generated by the name generation means.

The information transmitter according to the present invention for transmitting information to outside includes an image pickup unit, a code acquisition means that acquires a code from a piece of image data obtained by picking up an image by the image pickup unit, an analyzing means that analyzes the code acquired by the code acquisition means and acquires a piece of code information, and a transmission means that transmits to outside the piece of code information acquired by the analyzing means.

According to the present invention, the code acquisition means acquires the code from the piece of image data obtained by picking up the image by the image pickup unit, and the analyzing means analyzes the code thus acquired and transmits the piece of code information thus obtained to the outside. Accordingly, in order to acquire the piece of code information by analyzing the code, the piece of code information is not required to be stored, with the piece of code information previously corresponded to each code such as a two-dimensional bar code.

The information transmitter according to the present invention includes a display means that displays the piece of code information acquired by the analyzing means; and an instruction reception means that receives an instruction whether or not the piece of code information displayed on the display means is transmitted, wherein the transmission means transmits the piece of code information when an instruction to transmit the piece of code information is received by the instruction reception means.

According to the present invention, the piece of code information obtained by analyzing the code extracted from the piece of image data is displayed on the display means, and the instruction to transmit the piece of code information thus displayed is received by the instruction reception means. In addition, when the instruction to transmit the piece of code information is received, by transmitting the piece of code information, the transmission of inappropriate information, for example, is prevented.

The information transmitter according to the present invention includes an encoding means that encodes the piece of code information acquired by the analyzing means, wherein the transmission means sends the piece of code information encoded by the encoding means.

According to the present invention, the code acquired from the piece of image data is analyzed and the piece of code information thus obtained is encoded by the encoding means and then transmitted to the outside. Therefore, even when information of high confidentiality is leaked, an illegal use of the information becomes difficult.

The information transmitter according to the present invention includes a plurality of analyzing means respectively corresponding to different codes; and a selection means that selects, based on the code acquired by the code acquisition means, an analyzing means to analyze the code from the plurality of analyzing means, wherein the analyzing means selected by the selection means analyzes the code acquired by the code acquisition means.

According to the present invention, the plurality of analyzing means for analyzing the code acquired from the piece of image data are provided, and based on the code thus acquired, one of the plurality of analyzing means is selected, and the code is analyzed by the selected analyzing means. Accordingly, each code acquired from the piece of image data obtained by picking up the image of different codes can be properly analyzed by the analyzing means.

The information transmitter according to the present invention includes a storage means that stores the code acquired by the code acquisition means and the piece of code information acquired by analyzing the code by the analyzing means, for each analyzing means selected by the selection means.

According to the present invention, the code acquired from the piece of image data and the piece of code information obtained by analyzing the code are stored in a corresponding analyzing means, and then the piece of code information corresponding to the code acquired from the piece of image data obtained by properly picking up the image is selected from the piece of code information already stored, thereby making it possible to simplify an analyzing processing.

In the data storage system according to the present invention having the aforementioned information transmitter and the data storage device that stores the data in a hierarchical structure, the data storage means includes a reception means that receives the piece of code information transmitted from the information transmitter; and a name generation means that generates a folder name or a file name relating to the data, based on the piece of code information received by the reception means.

According to the present invention, the data storage means that stores the data in a hierarchical structure receives the piece of code information transmitted from the aforementioned information transmitter, and based on the piece of code information thus received, the folder name or the file name relating to the data is generated by the name generation means. Accordingly, based on the piece of code information acquired from the information transmitter having the image pickup unit, the folder name or the file name of each data stored in a hierarchical structure is generated, thereby making it possible to arbitrarily give the folder name or the file name of each data in the data storage device not having the image pickup unit.

The information processing system according to the present invention includes the aforementioned information transmitter and an information processor that performs a predetermined processing based on the piece of code information transmitted from the information transmitter.

According to the present invention, the information processor receives the piece of code information transmitted from the information transmitter, and based on the piece of code information thus received, the predetermined processing is performed, thus making it possible for the information processor not having the image pickup unit to acquire the information for performing the predetermined processing, from the information transmitter having the image pickup unit.

### Effects of the Invention

According to the present invention, for example, based on the code information corresponding to the code extracted from the image data obtained by picking up the image including the code such as a two-dimensional bar code, the folder name or the file name relating to each data acquired to be stored in the storage means is generated, thus making it possible to set the arbitrary folder name or file name, without adding the operation buttons to input the folder name or file name. Thus, based on the file name or folder name of each data, content of each data can be estimated, thus making it possible to reduce a processing load when each data is processed.

When the code information cannot be extracted from the image data thus obtained, predetermined information, for example, based on the acquisition time and date of the data acquired to be stored in the storage means and the order of storing the data in the storage means, the folder name or file name relating to each data is generated, thus, making it possible to surely generate the folder name or file name, even when the code information cannot be acquired from the image data obtained by the image pickup unit for generating the arbitrary folder name or file name. Further, when the code information cannot be extracted from the image data obtained by picking up the image, this message is reported, thus making it possible to report to each user a message that a generation processing of the arbitrary name of the folder or file by the instruction from each user fails.

According to the present invention, the folder of the folder name generated based on the code information extracted from the image data obtained by picking up the image by the image pickup unit, is generated in the storage means, thereby making it possible to prepare the folder of the arbitrary folder name in the storage means in which each acquired data is stored. Also, the file name or folder name of each data file already stored in the storage means is changed to the file name or folder name generated based on the code information extracted from the image data obtained by picking up the image by the image pickup unit, thereby making it possible to arbitrarily change the file name or folder name of the data file stored in the storage means.

According to the present invention, when the first processing is selected, the folder of the generated folder name is generated in the storage means, and when the second processing is selected, the file name or folder name of each data stored in the storage means is changed to the generated file name or folder name, thereby making it possible to switch the processing which is selected by the user, such that the folder is newly generated or the folder name or file name is changed. Accordingly, for example, in a digital camera in which the image data obtained by picking up the image is stored and the image data thus stored is reproduced, when switching of a recording processing and a reproduction processing is enabled, the folder is newly generated when an execution of the recording processing is selected, and the folder name or the file name is changed when the execution of the reproduction processing is selected.

According to the present invention, the code information is acquired by analyzing the code acquired from the image data obtained by picking up the image including the code, thereby eliminating the need to store the code, with the code information previously corresponded to each code. Thus, the code information obtained by analyzing the code acquired from the image data whose image is picked up by a device having the image pickup unit can be used in an external device. In addition, the code information obtained by analyzing the code is displayed, the instruction whether or not the code information thus displayed is transmitted is received, and the code information, which does not receive the instruction to transmit, is prevented from being transmitted to the outside, and only appropriate code information, for example, which receives the instruction to transmit, can be transmitted to the external device. Further, according to the present invention, the code information obtained by analyzing the code acquired from the image data is encoded and transmitted to the outside, thereby making it hard to use the information illegally even when the information of high confidentiality is leaked, and a security can be improved.

Still further, according to the present invention, a plurality of analyzing means for analyzing codes acquired from pieces of the image data are provided, thereby making it possible to appropriately analyze the codes extracted from respective pieces of the image data obtained by picking up images of different kind of codes. Also, by storing each code extracted from each piece of the image data and each piece of the code information obtained by analyzing the code for each corresponding analyzing means, it is only necessary to select the corresponding piece of the code information from the code information that is already stored. This eliminates the need for analyzing the code extracted from the image data obtained by appropriately picking up the image, and the load of an analyzing processing can be reduced.

According to the present invention, the data storage device that stores the data in a hierarchical structure generates the folder name or the file name relating to the data based on the code information transmitted from an external information transmitter, thereby making it possible to arbitrarily give the folder name or file name of each data even in the data storage device not having the image pickup unit. In addition, when the information processor performs the predetermined processing to the code information transmitted from the external information transmitter, the information processor not having the image pickup unit performs the predetermined processing based on the information acquired from the external information transmitter having the image pickup unit, thereby not requiring labor for inputting the information required for each kind of processing by an operation of an operation key.

### BRIEF DESCRIPTION OF THE SEVERAL VIEWS OF THE DRAWINGS

FIG. 1 is a block diagram showing an exemplary constitution of a digital camera according to an embodiment 1;

FIG. 2 is a schematic view showing an example of storage contents of a code information DB;

FIG. 3A is a schematic view showing an exemplary constitution of a folder list screen;

FIG. 3B is a schematic view showing an exemplary constitution of a thumbnail list screen;

FIG. 4 is a flowchart showing a generation processing procedure of a folder name or file name in the digital camera according to the embodiment 1;

FIG. 5 is a flowchart showing the generation processing procedure of the folder name or file name in the digital camera according to the embodiment 1;

FIG. 6 is a flowchart showing the generation processing procedure of the folder name or file name in the digital camera according to the embodiment 1;

FIG. 7 is a block diagram showing an exemplary constitution of the digital camera according to an embodiment 2;

FIG. 8 is a block diagram showing an exemplary constitution of a recording and reproducing apparatus according to the embodiment 2;

FIGS. 9A and 9B are schematic views showing an exemplary constitution of a name set screen;

FIG. 10 is a schematic view showing an example of a program name list sheet;

FIG. 11 is a flowchart showing the generation processing procedure of the folder name or file name by the digital camera according to the embodiment 2;

FIG. 12 is a flowchart showing the generation processing procedure of the folder name or file name by the digital camera according to the embodiment 2;

FIG. 13 is a schematic view showing an example of a broadcast program list sheet;

FIG. 14 is a flowchart showing a reservation recording processing procedure performed to the recording and reproducing apparatus by the digital camera according to an embodiment 3;

FIG. 15 is a block diagram showing an exemplary constitution of an information processing system according to the present invention;

FIG. 16 is a schematic view showing an example of a travel list sheet;

FIG. 17 is a schematic view showing an exemplary constitution of a user confirmation screen; and

FIG. 18 is a flowchart showing a travel application processing procedure by a cellular phone 5 according to an embodiment 4.

### BRIEF DESCRIPTION OF REFERENCE NUMERALS

1 Digital camera (data storage device)

10 CPU (folder generation means, name changing means, determination means)

13a Camera unit (image pickup unit)

14 Code recognition unit (extraction means)

15 Name generation unit (name generation means)

16 Display unit (report means, display means)

17 Recording medium (storage means)

18 Operation unit

18b Mode switch (reception means)

18c Name button

2 Digital camera (information transmitter)

20 Code extraction means (code acquisition means)

21 Decoder selection unit (Selection means)

22 Decoding unit (analyzing means)

23 Communication interface (transmission means)

3 Recording and reproducing apparatus (data storage device, information processor)

30 CPU (name generation means)

37 Communication interface (reception means)

5 Cellular phone (information transmitter)

50 CPU (encoding means)

53a Camera unit (image pickup unit)

55 Display unit (display means)

56 Code extraction means (code acquistion means)

57 Decoder selection unit (selection means)

58 Decoding unit (analyzing means)

59 Communiation interface (transmission means)

6 Computer (information processor)

60 CPU

### BEST MODE FOR IMPLEMENTING THE INVENTION

### EMBODIMENT 1

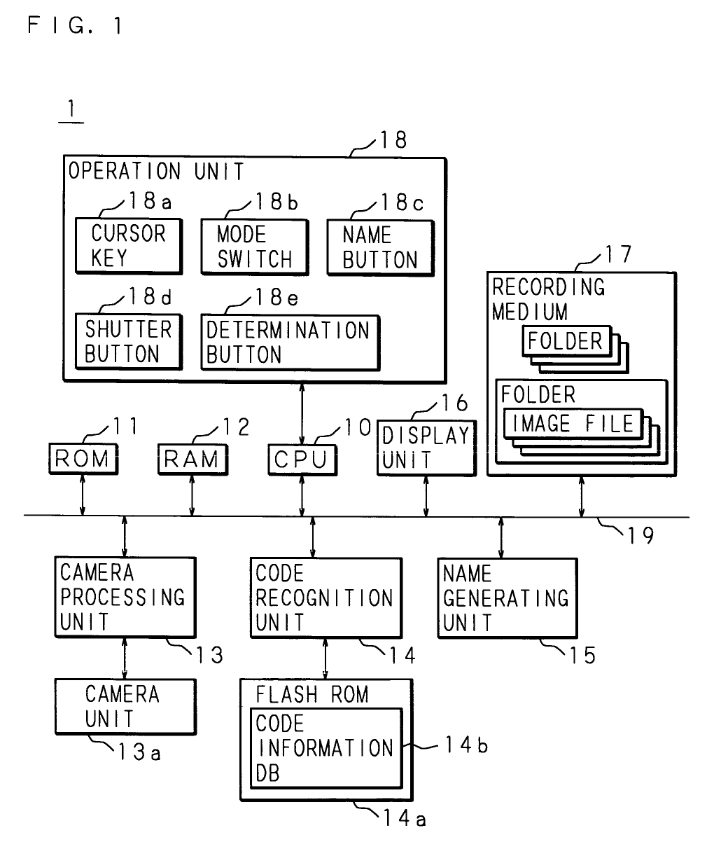

A data storage device according to the present invention will be explained in detail hereunder, based on the drawings showing a digital camera as an embodiment 1 thereof. FIG. 1 is a block diagram showing an exemplary constitution of the digital camera as the data storage device according to the present invention. A designation mark “1” in the figure indicates the digital camera as the data storage device according to the present invention, and the digital camera 1 comprises a CPU (Central Processing Unit) 10, a ROM 11, a RAM 12, a camera processing unit 13, a code recognition unit 14, a name generation unit 15, a display unit 16, and a recording medium 17, etc, each being mutually connected via a bus 19.

The CPU 10 functions as a control center of the digital camera 1 and controls each part of the aforementioned hardware mutually connected via a bus 19, and also realizes various software-based functions, following control programs previously stored in the ROM 11. The ROM 11 previously stores various control programs required for operating the digital camera 1 as the data storage device of the present invention. The RAM 12 is composed of SRAM or a flash memory, etc, and temporarily stores data that is generated when the control programs are executed by the CPU 10.

A camera processing unit 13 is connected to a camera unit 13a as an image pickup unit composed of CCD (Charge Couple Device), wherein by picking up the image by the camera 13a at a timing following the control of the CPU 10, image data is fetched, and the image data thus obtained is subjected to a predetermined processing and then is recorded in a recording medium 17 via the bus 19. In addition, the camera processing unit 13 transmits the image data subjected to the predetermined processing to the code recognition unit 14 or the display unit 16 also as needed.

The recording medium 17 is composed of a memory card, a magnetic medium, a photomagnetic medium, or a semiconductor memory, etc, and is operated as the storage means that stores the image data acquired from the camera processing unit 13. In addition, the recording medium 17 according to this embodiment stores each image data as an image file managed for each folder previously set in an appearance of a hierarchical structure.

The display unit 16 is composed of a liquid crystal display (LCD), and displays an operation state of the digital camera 1, information to be reported to a user, and the image data obtained by picking up the image by the camera 13a, and so forth. In addition, by making the display unit 16 a touch panel type, a unit or the whole unit of each kind of key of the operation unit 18 can be substituted.

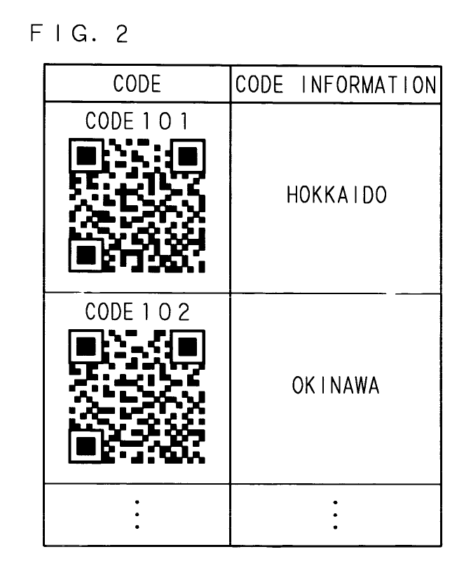

A flash ROM 14a is connected to the code recognition unit 14, and a code information DB (Table) 14b is stored in the flash ROM 14a. As shown in FIG. 2, the code information DB 14b stores codes each constituted by a two-dimensional bar code, and pieces of the code information respectively corresponding to the codes.

The code recognition unit 14 recognizes whether or not there is a code included in the code information DB 14b in a piece of the image data transmitted from the camera processing unit 13 as needed. When recognizing the code included in the code information DB 14b is in the piece of the image data, a piece of the code information corresponding to the recognized code is read from the code information DB 14b and the piece of the code information thus read is transmitted to the name generation unit 15. Accordingly, the code recognition unit 14 functions as the extraction means that extracts the piece of the code information corresponding to the code included in the piece of the image data, based on the piece of the image data obtained by picking up the image by the camera unit 13a.

The name generation unit 15 functions as the name generation means that generates the folder name or file name in an image file stored in the recording medium 17, based on the code information transmitted from the code recognition unit 14. The name generation unit 15 reports the generated folder name or file name to the CPU 10, and the CPU 10 functions as a folder generation means that generates in the recording medium 17 the folder of the folder name generated by the name generation unit 15, following the instruction from the user. Also, the CPU 10 functions as the name changing means that changes the folder name or file name in the image file already stored in the recording medium 17, to the name generated by the name generation unit 15.

The CPU 10 is connected to the operation unit 18. The operation unit 18 is provided with each kind of keys required for operating the digital camera 1 by the user, specifically a cursor key 18a formed of a cross button, a mode switch 18b, a name button 18c, a shutter button 18d, and a determination button 18e, etc. The mode switch 18b is a switch for switching a recording processing (recording mode) as a first processing to a reproduction processing (reproduction mode) as a second processing, and functions as a reception means that receives a selection of the first processing or the second processing.

The name button 18c is a button for giving an instruction to execute the generation processing that generates the folder name or file name relating to the image file stored in the recording medium 17. The shutter button 18d is the button for giving the instruction of the timing of fetching a piece of the image data as a static image from pieces of the image data sequentially acquired by the camera unit 13a. The determination button 18e is the button used for performing each kind of selection and processing. When the user operates each key, the operation unit 18 sends to the CPU 10 a control signal corresponding to an operated key, and the CPU 10 executes the processing corresponding to an acquired control signal.

In the digital camera 1 having the above-described structure, when a recording mode is selected by the mode switch 18b of the operation unit 18, the CPU 10 operates the camera processing unit 13 and the display unit 16 and transmits pieces of the image data sequentially acquired by the camera 13a to the display unit 16 via the bus 19 and displayed it on the display unit 16. Also, when the recording mode is selected, the CPU 10 fetches a piece of the image data from the pieces of the image data sequentially acquired by the camera unit 13a at the timing of turning on the shutter button 18d, and when the shutter button 18d is turned on by the user, records the piece of the image data in the recording medium 17 as the image file, and displays the image file on the display unit 16. Note that the file name for recording such a new image file in the recording medium 17 is given based on a photographing time and date and an order to be recorded in the recording medium 17.

Meanwhile, when a folder is desired to be newly prepared in a desired folder of the recording medium 17, the name button 18c is turned on, with the recording mode selected by the mode switch 18b. In this state, the image of the code corresponding to a desired piece of the code information is picked up by the camera unit 13a. Note that the code information DB 14b shown in FIG. 2 is previously printed as a code list sheet on a recording paper, and the image of a desired code in the code list sheet is picked up by the camera unit 13a.

Accordingly, under the selection of the recording mode, the CPU 10 inputs the piece of the image data fetched by the camera unit 13a in the code recognition unit 14 when the name button 18c is turned on and further when the shutter button 18d is turned on by the user. In addition, the code recognition unit 14 recognizes whether or not there is a code included in the code information DB 14b is contained in the piece of the image data thus acquired, and when the code is recognized in the piece of the image data, reads a piece of the code information corresponding to the recognized code from the code information DB 14b and transmits the piece of the code information to the name generation unit 15. The name generation unit 15 generates the folder name based on the code information thus acquired from the code recognition unit 14. In addition, the folder name thus generated is reported to the CPU 10, and the CPU 10 prepares the folder of the folder name thus reported in a designated folder.

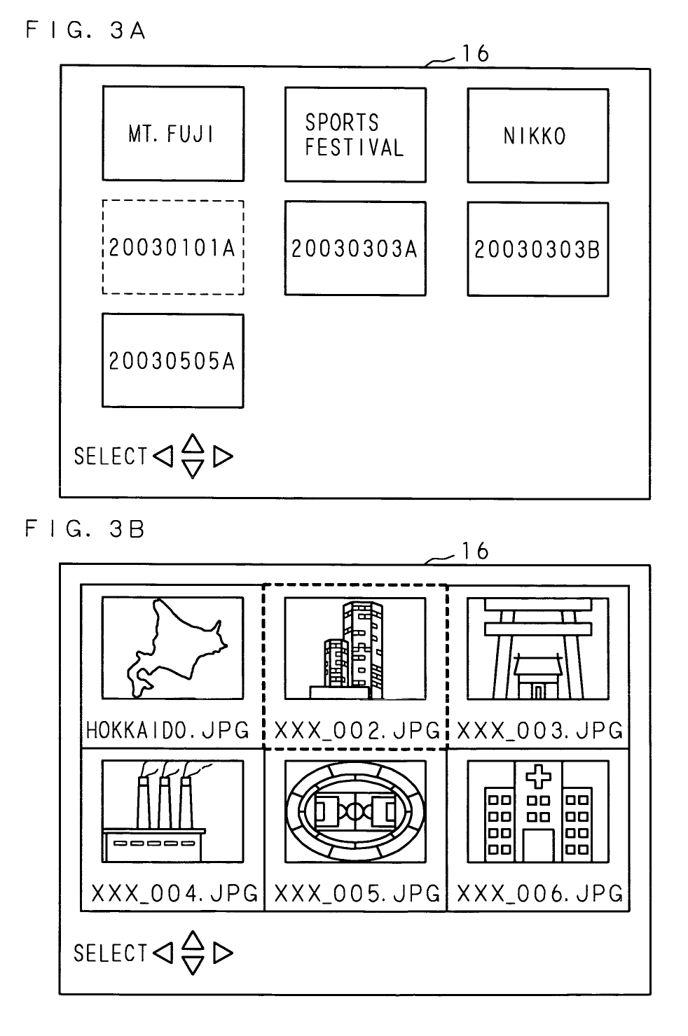

In the digital camera 1 having the above-described structure, when the reproduction mode is selected by the mode switch 18b of the operation unit 18, as shown in FIGS. 3A and 3B, the CPU 10 displays on the display unit 16 a selection screen for selecting the image file stored in the recording medium 17 in a hierarchical structure. Note that FIG. 3A is a schematic view showing an exemplary constitution of a folder list screen, and each square in the figure indicates the folder, and each folder name is indicated in the square. Also, FIG. 3B is a schematic view showing an exemplary constitution of a thumbnail list screen, and each square in the figure indicates each image file, and the thumbnail image and the file name of each image file are shown in the square. Further, in the selection screen, in addition to the screen shown in FIGS. 3A and 3B, a list screen in which the folder and the thumbnail are mixed can also be displayed.

In the folder list screen shown in FIG. 3A, the user selects the folder, in which a desired image file is stored, by the cursor key 18a and turns on the determination button 18e. In FIG. 3A, the folder of the folder name “20030101A” is selected. When the determination button 18e is turned on, as shown in FIG. 3B, the CPU 10 displays on the display unit 16 the thumbnail list screen of the image file stored in the folder of “20030101A”. In FIG. 3B, in the same way, the image file of the file name “XXX_{—}002.JPG” is selected. When the determination button 18e is turned on, the CPU 10 reads the image file of selected “XXX_{—}002.JPG” from the recording medium 17 and displays it on the display unit 16. Thus, the user can read the desired image file from the recording medium 17 and confirm it by the display unit 16.

Further, when the folder name or file name relating to the image file stored in the recording medium 17 is desired to be changed, the user selects the reproduction mode by the mode switch 18b, and by using the cursor key 18a, selects the folder or file, whose name is desired to be changed, and turns on the name button 18c. In this state, the image of the code corresponding to the desired piece of the code information can be picked up by the camera unit 13a.

Accordingly, when the reproduction mode is selected, the CPU 10 inputs the piece of the image data acquired by the camera unit 13a in the code recognition unit 14, when the name button 18c is turned on and the shutter button 18d is turned on by the user. The code recognition unit 14 recognizes whether or not there is the code included in the code information DB 14b in the acquired piece of the image data, and when the code is recognized in the piece of the image data, reads the piece of the code information corresponding to the recognized code from the code information DB 14b and transmits it to the name generation unit 15. The name generation unit 15 generates the folder name based on the piece of the code information acquired from the code recognition unit 14.

When the folder is selected by the cursor key 18a, the folder name of the selected folder is generated, and when the file is selected, the file name of the selected file is generated. The folder name or file name thus generated are reported to the CPU 10, and the CPU 10 changes the folder name or file name selected to change the name, to a reported folder name or file name. Accordingly, as shown in FIG. 3A, the arbitrary folder name can be given, such as “Mt. Fuji”, “Sports Festivar”, and “Nikko”, etc, and as shown in FIG. 3B, the arbitrary folder name such as “Hokkaido.JPG” can be given.

Here, in order to generate the folder name or file name, when the code included in the code information DB 14b cannot be recognized in the piece of the image data acquired by the camera unit 13a, for example, when the image of the code not registered in the code information DB 14b is picked up, or when the image not related to the code is picked up, the folder name or file cannot be generated based on the code information corresponding to a recognized code. Accordingly, when the code is not recognized from the image data acquired by the camera processing unit 13, the code recognition unit 14 reports accordingly to the CPU 10.

Based on the report from the code recognition unit 14, the CPU 10 functions as a determination means that determines whether or not the code in the piece of the image data is recognized by the code recognition unit 14 and the corresponding piece of the code information can be extracted. When it is determined that the code cannot be recognized in the piece of the image data, a signal showing accordingly is sent to the name generation unit 15. When the signal is acquired from the CPU 10 showing that the code cannot be recognized in the piece of the image data by the code recognition unit 14, the name generation unit 15 generates the folder name or file name based on the predetermined information. Specifically, the name generation unit 15 generates the folder name or file name, based on the photographing time and date and the time and date of executing a changing processing of the name of the folder or file. For example, when a first folder is prepared on Nov. 4, 2003, the folder name such as “20031104A” can be generated.

Further, when the code recognition unit 14 determines that the code cannot be recognized in the piece of the image data, the CPU 10 displays on the display unit 16 a message that the generation processing of the arbitrary name designated by the user fails. Thus, the display unit 16 functions as a report means that reports to the user the message that the arbitrary name cannot be generated.

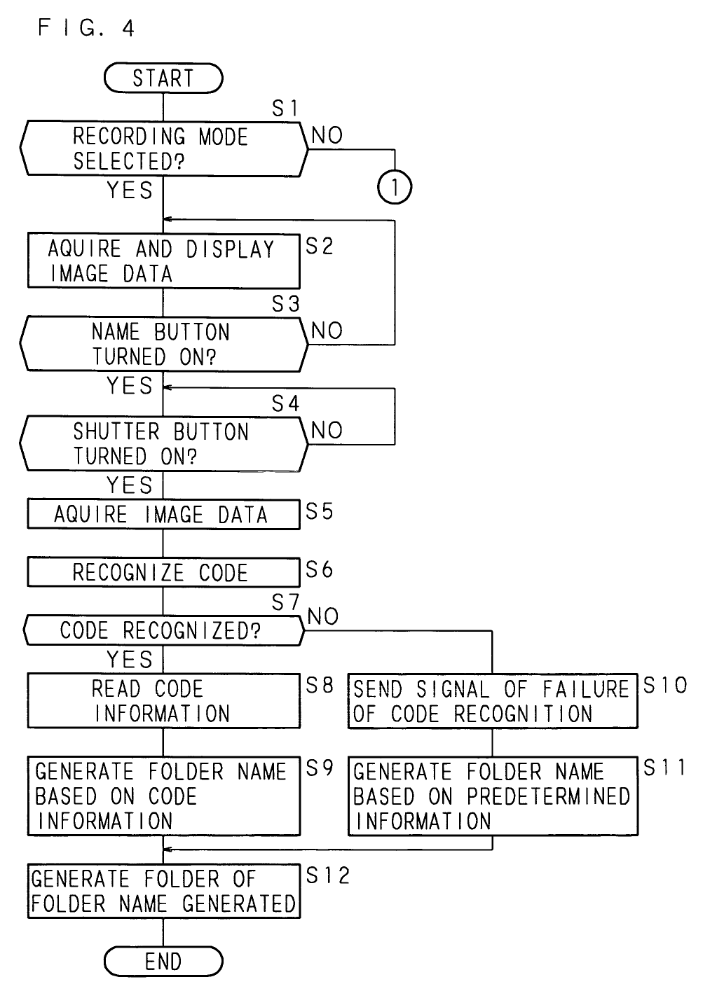

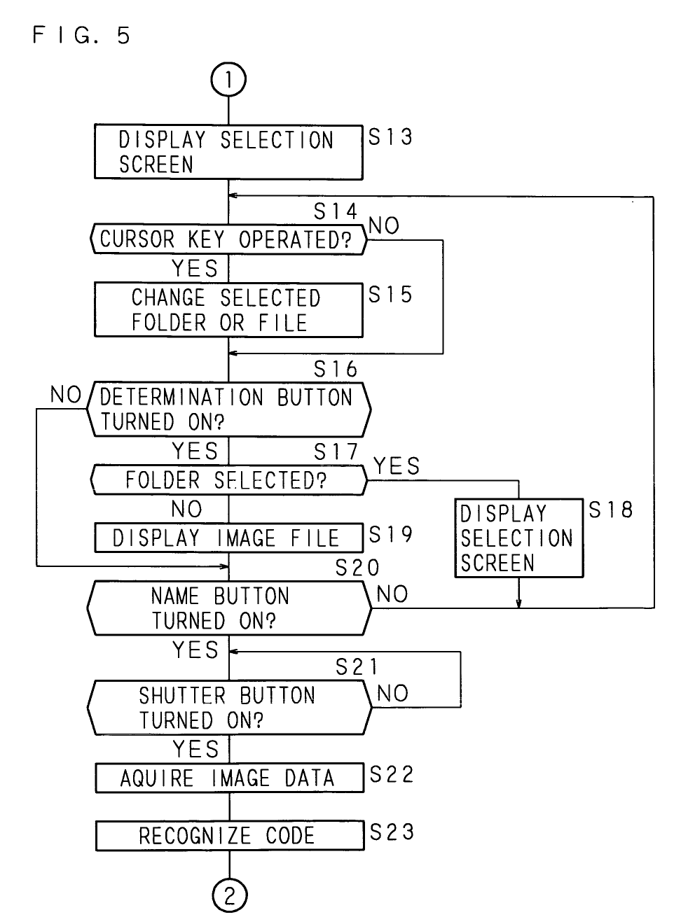

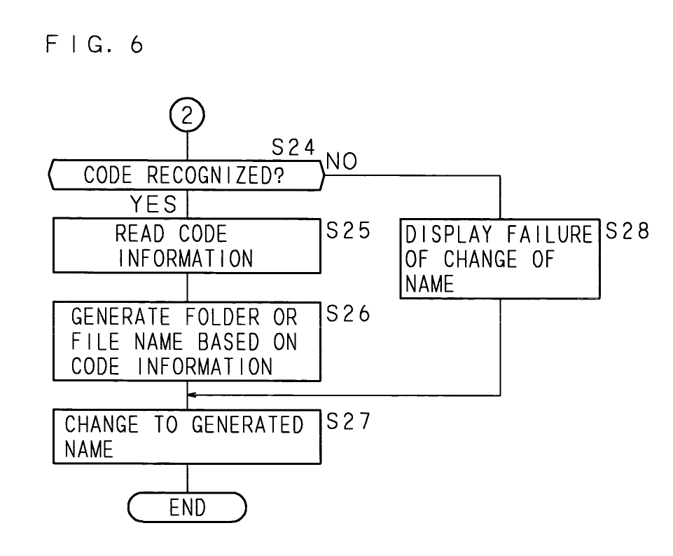

Hereunder, the generation processing of the folder name or file name relating to the image file stored in the recording medium 17 will be explained in the digital camera 1 having the above-described structure. FIG. 4 to FIG. 6 are flowcharts showing a generation processing procedure of the folder name or file name in the digital camera 1 according to the embodiment 1. In the digital camera 1, the user selects the recording mode or reproduction mode by operating the mode switch 18b of the operation unit 18 in accordance with cases such as preparing a new folder in the recording medium 17 or changing the file name or folder name of the image file already recorded.

In the digital camera 1, the CPU 10 determines whether or not the recording mode is selected by the user (S1), when determining that the recording mode is selected (S1: YES), starts the camera processing unit 13 and the display unit 16, and sequentially transmits the pieces of the image data acquired by picking up the image by the camera unit 13a to the display unit 16 via the bus 19, and displays it on the display unit 16 (S2). Next, the user turns on the name button 18c for generating the folder name newly prepared in the recording medium 17.

The CPU 10 determines whether or not the name button 18c of the operation unit 18 is turned on (S3), and when determining that the name button 18c is not turned on (S3: NO), the processing is returned to step S2, and the pieces of the image data acquired by the camera unit 13a are sequentially displayed on the display unit 16 until the name button 18c is turned on. Also, when determining that the name button 18c is turned on (S3: YES), the CPU 10 determines whether or not the shutter button 18d is turned on by the user (S4), and when the shutter button 18d is not turned on (S4: NO), the CPU 10 stands by until the shutter button 18d is turned on.

Next, the user turns on the shutter button 18d to pick up the image of a desired code from a code list sheet as shown in FIG. 2 by the camera unit 13a. When the CPU 10 determines that the shutter button 18d is turned on (S4: YES), the CPU 10 fetches a piece of the image data acquired by the camera unit 13a, i.e. the piece of the image data obtained by picking up the image of the desired code here (S5), and inputs in the code recognition unit 14 the piece of the image data outputted from the camera processing unit 13.

Next, the CPU 10 causes the code recognition unit 14 to recognize whether or not either one of the codes in the code information DB 14b of a flash ROM 14a is included in the piece of the image data thus inputted (S6). When the code in the code information DB 14b cannot be recognized in the acquired piece of the image data, the code recognition unit 14 reports accordingly to the CPU 10. Then, based on this report, the CPU 10 determines whether or not the code can be recognized from the piece of the image data acquired by the camera unit 13a (S7).

When the code can be recognized from the piece of the image data acquired by the camera unit 13a (S7: YES), the code recognition unit 14 reads the piece of the code information corresponding to the recognized code from the code information DB 14b (S8), and transmits the piece of the code information thus read to the name generation unit 15. The name generation unit 15 generates the folder name based on the piece of the code information acquired from the code recognition unit 14 (S9), and reports the folder name thus generated to the CPU 10.

Meanwhile, when determining that the code cannot be recognized from the piece of the image data obtained by the camera unit 13a (S7: NO), the CPU 10 sends to the name generation unit 15 a signal showing that the code cannot be recognized by the code recognition unit 14 (S10). The name generation unit 15 that acquires the signal generates the folder name based on the predetermined information (S11), and reports the folder name thus generated to the CPU 10. The CPU 10 prepares the folder of the folder name generated and reported by the name generation unit 15 in a predetermined place of the recording medium 17 (S12).

Meanwhile, when the folder name or file name in the image file already recorded in the recording medium 17 is desired to be changed, the user operates the mode switch 18b of the operation unit 18 and selects the reproduction mode. When the CPU 10 determines that the recording mode is not selected by the user (S1: NO), that is, when the reproduction mode is selected by the user, the CPU 10 displays a selection screen such as a folder list screen and a thumbnail list screen on the display unit 16 as shown in FIGS. 3A and 3B to receive the change of the folder name or file name in each image file recorded in the recording medium 17 (S13). The user operates the cursor key 18a to select the folder or file whose name is desired to be changed by using the selection screen.

The CPU 10 determines whether or not the cursor key 18a is operated by the user (S14), and when determining that the cursor key 18a is operated (S14: YES), changes a selected folder or file, following the cursor key 18a thus operated (S15). In addition, when determining that the cursor key 18a is not operated (S14: NO), the CPU 10 skips the processing of the step S15.

The user selects the folder by using the cursor key 18a and turns on the determination button 18e, to select the file in the folder shown in the selection screen. The CPU 10 determines whether or not the determination button 18e is turned on by the user (S16), and when determining that the determination button 18e is turned on (S16: YES), determines whether or not the folder is selected by the cursor key 18a (S17). Here, when determining that the folder is selected (S17: YES), the CPU 10 displays the selection screen including the folder list screen and the thumbnail list screen for selecting the folder and the file in the selected folder (S18), and the processing is returned to step S14. Note that when determining that the determination button 18e is not turned on (S16: NO), the CPU 10 skips the processing until step S20.

Also, when determining that the folder is not selected by the cursor key 18a (S17: NO), that is, when the image file is selected by the cursor key 18a, the CPU 10 reads the selected image file from the recording medium 17 and displays it on the display unit 16 (S19). Next, the user turns on the name button 18c of the operation unit 18, to change the name of an image file displayed on the display unit 16 or the folder or image file selected in step S15 without turning on the determination button 18e in step S16.

The CPU 10 determines whether or not the name button 18c of the operation unit 18 is turned on (S20), and when determining that the name button 18c is not turned on (S20: NO), the processing is returned to step S14. Also, when determining that the name button 18c is turned on (S20: YES), the CPU 10 determines whether or not the shutter button 18d is turned on by the user (S21), and when the shutter button 18d is not turned on (S21: NO), the CPU 10 stands by until the shutter button 18d is turned on.

The user turns on the shutter button 18d, to pick up the image of a desired code from the code list sheet as shown in FIG. 2 by the camera unit 13a. When determining that the shutter button 18d is turned on (S21: YES), the CPU 10 fetches the piece of the image data acquired by the camera unit 13a, i.e. the piece of the image data obtained by picking up the image of the desired code (S22), and inputs the piece of the image data outputted from the camera processing unit 13 in the code recognition unit 14.

Next, the CPU 10 causes the code recognition unit 14 to recognize whether or not either of the codes in the code information DB 14b of the flash ROM 14a is included in the inputted piece of the image data (S23). When the code in the code information DB 14b cannot be recognized in the acquired piece of the image data, the code recognition unit 14 reports accordingly to the CPU 10, and based on this report, the CPU 10 determines whether or not the code can be recognized from the piece of the image data acquired by the camera unit 13a (S24).

When the code can be recognized from the piece of the image data acquired by the camera unit 13a (S24: YES), the code recognition unit 14 reads the piece of the code information corresponding to the recognized code from the code information DB 14b (S25), and transmits the piece of the code information thus read to the name generation unit 15. The name generation unit 15 generates the name of the folder or file selected by the cursor key 18a, based on the piece of the code information acquired from the code recognition unit 14 (S26), and reports to the CPU 10 the folder name or file name thus generated. Thus, the CPU 10 changes the folder name or file name selected by the user, to the name generated by the name generation unit 15 (S27).

Meanwhile, when determining that the code is not obtained from the piece of the image data obtained by the camera unit 13a (S24: NO), the CPU 10 displays on the display unit 16 the message that the changing processing of the folder name or file name selected by the cursor key 18a fails (S28), and terminates the changing processing of the name.

As described above, in the digital camera 1 according to this embodiment 1, the arbitrary folder name or file name can be given based on the piece of the code information corresponding to the bar code, whose image is picked up by the camera unit 13a, and when the piece of the code information corresponding to the bar code, whose image is picked up, is not previously prepared, the folder name or file name can be surely generated based on the predetermined information.

In the digital camera 1 of the aforementioned embodiment 1, the code information DB 14b is previously prepared, in which the piece of the code information is stored correspondingly to each code such as a two-dimensional bar code, and based on the piece of the code information corresponding to the code extracted from the piece of the image data obtained by picking up the image, the folder name or file name is generated. However, a piece of code information not previously registered in the code information DB 14b may also be acquired from outside and added to the code information DB 14b. Note that when the piece of the code information is thus added to the code information DB 14b, for example, a list table of HIRAGANA is displayed on the display unit 16, and each HIRAGANA name is selected by operating the cursor key 18a by the user, whereby the new piece of the code information can be inputted. Further, the digital camera 1 is connected to a computer via a cable, and the piece of the code information can also be added from a keyboard, etc, provided in the computer. Note that a QR code (registered trademark) can be used as the two-dimensional bar code stored in the code information DB 14b.

In addition, the recording medium 17 in the aforementioned embodiment is composed of the memory card, magnetic medium, photomagnetic medium or semiconductor memory and so forth, and it may be constituted in either way that can be removed from the digital camera 1 or cannot be removed.

The data storage device according to the present invention is not only used in the embodiment by the digital camera 1 as described above, but also can be applied to the cellular phone with camera. In addition, it can be applied not only to a device that records the acquired piece of the image data but also to the cellular phone and PDA and so forth that records acquired video data including the piece of the image data and voice data. Further, it can also be applied to a voice recorder for recording acquired voice data, when the camera and the display unit are provided therein.

### EMBODIMENT 2

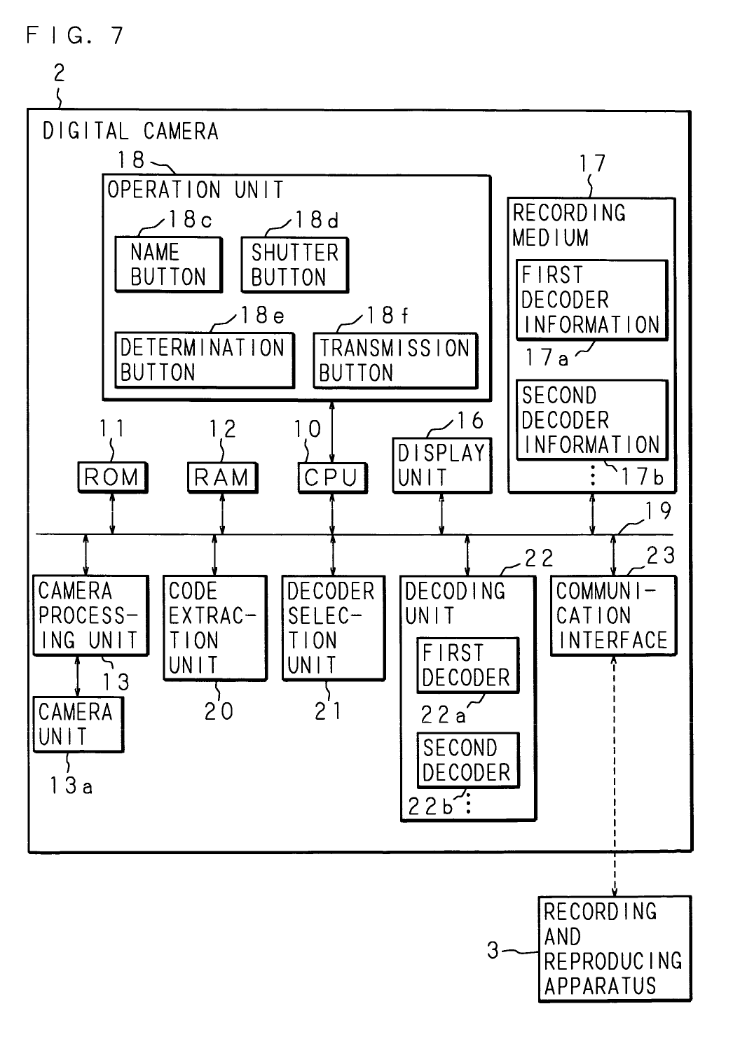

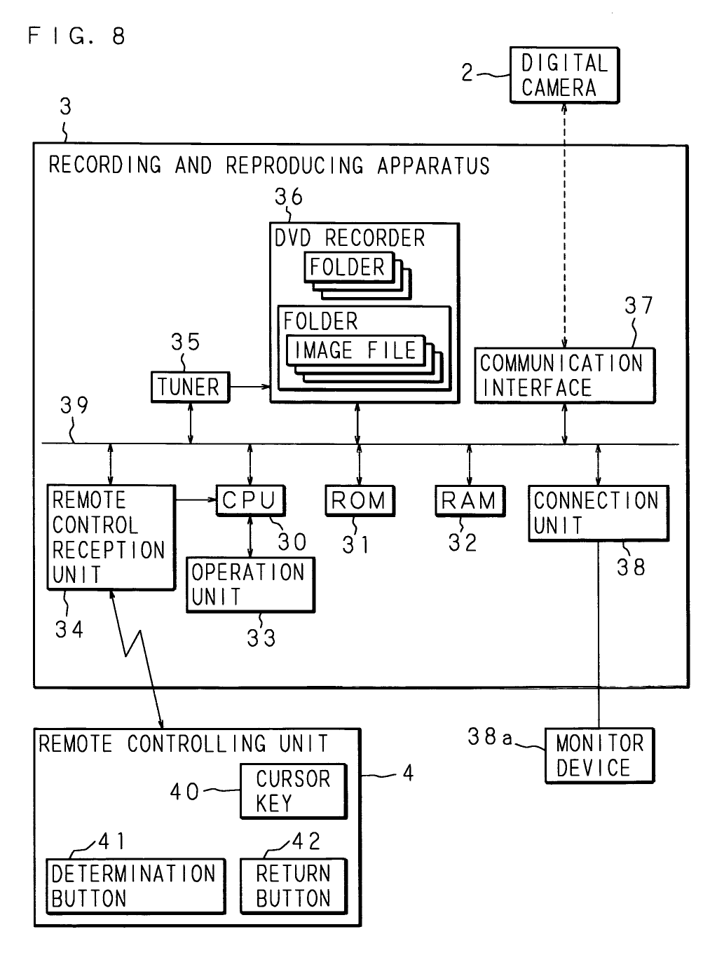

The data storage system according to the present invention will be explained in detail hereunder, based on the drawings showing the embodiment 2. FIG. 7 is a block diagram showing an exemplary constitution of the digital camera in the data storage system according to the present invention, and FIG. 8 is a block diagram showing an exemplary constitution of the recording and reproducing apparatus in the data storage system according to the present invention.

The data storage system of this embodiment 2 is composed of a digital camera 2 as the information transmitter of the present invention, and a recording and reproducing apparatus 3 as the data storage device of the present invention. A wireless communication following IrDA (Infrared Data Association) standard using infrared rays is possible between the digital camera 2 and the recording and reproducing apparatus 3. Note that not only the wireless communication using the infrared rays, but also the wireless communication such as a wireless LAN pursuant to IEEE 802.11b standard, and the wireless communication following the Bluetooth standard may also be possible between the digital camera 2 and the recording and reproducing apparatus 3.

In the data storage system according to this embodiment 2, the recording and reproducing apparatus 3 records each broadcast program received by a tuner 35 (see FIG. 8) as the image file for each folder previously set in a DVD in an appearance of a hierarchical structure. In addition, the digital camera 2 picks up the image of the bar code wherein a word used in the file name and the folder name of the broadcast program recorded in the recording and reproducing apparatus 3 is coded, analyzes the image data thus obtained to acquire the code information (word), and transmits the code information thus obtained to the recording and reproducing apparatus 3 by wireless communication.

The recording and reproducing apparatus 3 that receives the code information from the digital camera 2 generates the file name or folder name of each image file of its own recording, based on received code information. Thus, the file name and folder name of the image file of the broadcast program recorded in the recording and reproducing apparatus 3 can be arbitrarily added.

An internal constitutional example of the digital camera 2 and the recording and reproducing apparatus 3 constituting the data storage system of this embodiment 2 will be explained hereunder. Note that in the digital camera 2 of this embodiment 2 shown in FIG. 7, the unit having the same structure as that of the digital camera 1 of the aforementioned embodiment 1 is designated by the same signs and numerals, and an explanation is omitted.

As shown in FIG. 7, the digital camera 2 according to this embodiment 2 comprises a code extraction unit 20, a decoder selection unit 21, a decoding unit 22, and a communication interface (communication unit) 23 for communicating with an external recording and reproducing apparatus 3 and so forth, each being mutually connected via the bus 19, in addition to the CPU 10, ROM 11, RAM 12, camera processing unit 13, display unit 16, and recording medium 17.

In the digital camera 2 of this embodiment 2, the operation unit 18 comprises a transmission button 18f and so forth, in addition to the name button 18c, shutter button 18d, and determination button 18e. The transmission button 18f is, for example, a button used for transmitting the code information decoded by the decoding unit 22 to the recording and reproducing apparatus 3 from the communication interface 23. Following the control from the CPU 10, the camera processing unit 13 of the digital camera 2 transmits the image data obtained by picking up the image by the camera unit (image pickup unit) 13a to the code extraction unit 20 via the bus 19, after the image data is subjected to a predetermined processing. The code extraction unit 20 detects whether or not the code previously coded by the predetermined processing is included in the image data transmitted from the camera processing unit 13. When the code is detected in the image data, the code extraction unit functions as the code acquisition means that acquires the code thus detected, and transmits the code thus acquired (extracted) to the decoder selection unit 21 and the decoding unit 22.

Here, the digital camera 2 of this embodiment 2 has a plurality of decoders of first decoder 22a, second decoder 22b . . . in the decoding unit 22, as the analyzing means that analyzes the code extracted by the code extraction unit 20 to acquire the code information. The decoder selection unit 21 functions as the selection means that selects the decoder capable of analyzing the code based on the code transmitted from the code extraction unit 20. The CPU 10 causes the decoder selected by the decoder selection unit 21 to analyze the code extracted by the code extraction unit 20. Thus, the digital camera 2 can perform a decode processing using a proper decoder in accordance with the kind of the code extracted by the code extraction unit 20.

The communication interface 23 functions as a transmitter that transmits to an external recording and reproducing apparatus 3 the code information obtained by analyzing the code extracted from the image data acquired by the camera unit 13a by the proper decoder of the decoding unit 22, as described above. The CPU 10 displays the code information decoded by the proper decoder as described above on the display unit (display means) 16. The user inputs by operating the transmission button 18f of the operation unit 18 an instruction whether or not displayed code information is transmitted to the recording and reproducing apparatus 3, based on whether or not the displayed code information is properly decoded.

The CPU 10 functions as an instruction reception means that receives the instruction whether or not the code information displayed on the display unit 16 is transmitted to the recording and reproducing apparatus 3, based on whether or not the transmission button 18f is operated by the user. When the transmission button 18f is operated by the user, the CPU transmits the code information displayed on the display unit 16 to the external recording and reproducing apparatus 3 from the communication interface 23. Thus, transmission of the code information, which is not properly decoded, to the recording and reproducing apparatus 3 can be prevented.

The recording medium 17 of the digital camera 2 functions as the storage means that stores, for each corresponding decoder, the code extracted from the image data by the code extraction unit 20 and the code information obtained by decoding the code by the proper decoder. Thus, the code already analyzed once is not required to be subjected to re-analyzing processing, and a processing load can be reduced.

Meanwhile, as shown in FIG. 8, the recording and reproducing apparatus 3 comprises a CPU 30, a ROM 31, a RAM 32, a remote control reception unit 34, a tuner 35, a DVD recorder 36, a communication interface 37 for communicating with the digital camera 2, and a connection unit 38, etc, for connecting with a monitor device 38a such as a liquid display television device and so forth, via a video cable for a video signal and a voice cable for a voice signal, each being mutually connected via a bus 39.

The CPU 30 functions as a control center of the recording and reproducing apparatus 3, controls each unit of the aforementioned hardware connected to one another via the bus 39, and realizes various software-based functions, following the control programs previously stored in the ROM 31. The ROM 31 previously stores various control programs required for operating the recording and reproducing apparatus 3 as the data storage device of the present invention. The RAM 32 is composed of the SRAM or flash memory, etc, and temporarily stores the data generated when the control programs are executed by the CPU 30.

The remote control reception unit 34 receives the infrared rays from a remote controlling unit (hereinafter referred to as a remote controller) 4, converts it into a predetermined electrical signal, analyzes the electric signal thus obtained and detects the control signal inputted from the remote controller, and reports the control signal thus detected to the CPU 30. Thus, the CPU 10 reads the control programs corresponding to the control signal acquired by the remote control reception unit 34 from the ROM 31 to the RAM 32, and sequentially executes them.

In addition, the remote controller 4 has a cursor key 40, a determination button 41, and a return button 42, etc, and the return button 42 is the button used for returning to an operation mode immediately before operating various kinds of operation buttons by the user. Also, between the recording and reproducing apparatus 3 and the remote controller 4, not only the wireless communication following the IrDA standard using the infrared rays is possible, but also the wireless communication such as the wireless LAN pursuant to the IEEE 802.11b standard and the wireless communication following the Bluetooth standard may be possible.

An operation unit 33, having each kind of key with which the user directly operates the recording and reproducing apparatus 3, is also connected to the CPU 30. When each key is operated by the user, the operation unit 33 reports to the CPU 30 the control signal corresponding to an operated key, and in the same way as the control signal acquired by the remote control reception unit 34, the CPU 30 reads from the ROM 31 to the RAM 32 the control programs corresponding to the control signal sent from the operation unit 33, and sequentially executes them.

The tuner 35 is a tuner for receiving UHF television broadcasting signal and VHF television broadcasting signal, BS broadcasting signal or CS broadcasting signal, etc, and receives a broadcasting signal corresponding to a broadcast channel selected by the user, and inputs it in the DVD recorder 36. The DVD recorder 36 is constituted, so that an insertion and a removal of a writable DVD is possible, and records the broadcasting signal inputted from the tuner 35 by the DVD inserted into a predetermined position according to the CPU 30. In addition, the DVD recorder 36 stores the broadcasting signal inputted from the tuner 35, as the image file managed for each folder previously set in an appearance of a hierarchical structure.

In the data storage system having the digital camera 2 and the recording and reproducing apparatus 3 having the above-described structure, by the proper decoder of the decoding unit 22, the digital camera 2 analyses the code extracted from the image data acquired by the camera unit 13a, and transmits the code information thus obtained to the recording and reproducing apparatus 3 from the communication interface 23. In this case, the recording and reproducing apparatus 3 receives the code information from the digital camera 2 by a communication interface (communication unit, reception means) 37. Based on the code information thus received, the CPU 30 functions as the name generation means that generates the file name or folder name in each broadcast program stored in the DVD recorder 36.

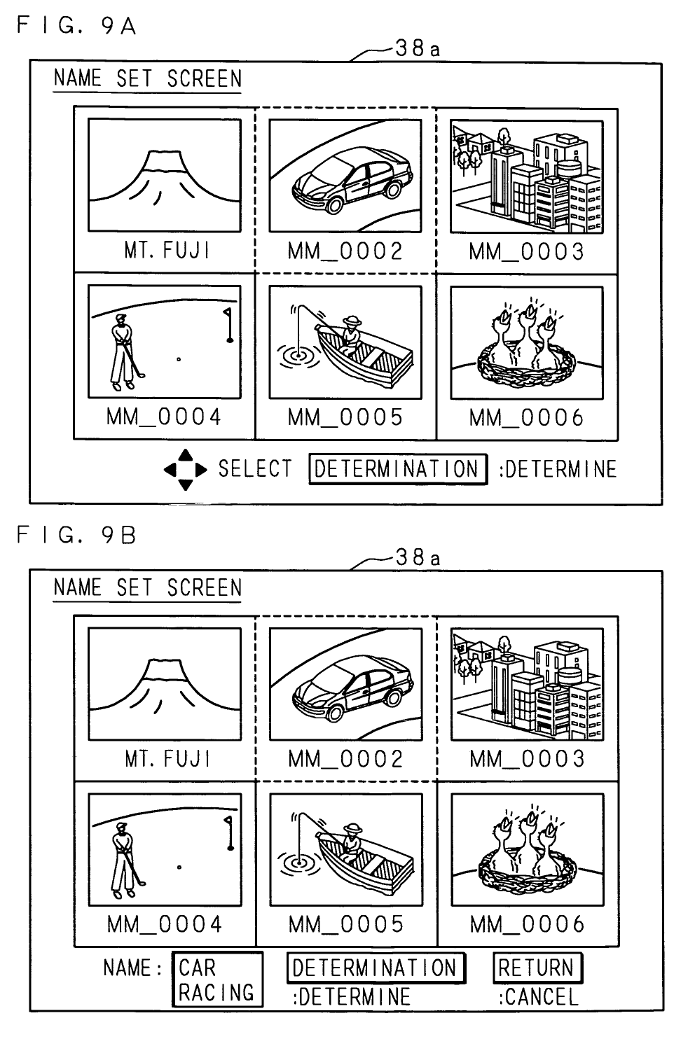

Specifically, when the user desires to add an arbitrary file name (program name) or folder name to a certain broadcast program recorded in the recording and reproducing apparatus 3, by operating a specified operation button of the operation unit 33 of the recording and reproducing apparatus 3 or a specified operation button of the remote controller 4, a name set screen, as shown in FIG. 9A, is displayed on the monitor device 38a. Note that such screen information is previously stored in the ROM 31 of the recording and reproducing apparatus 3.

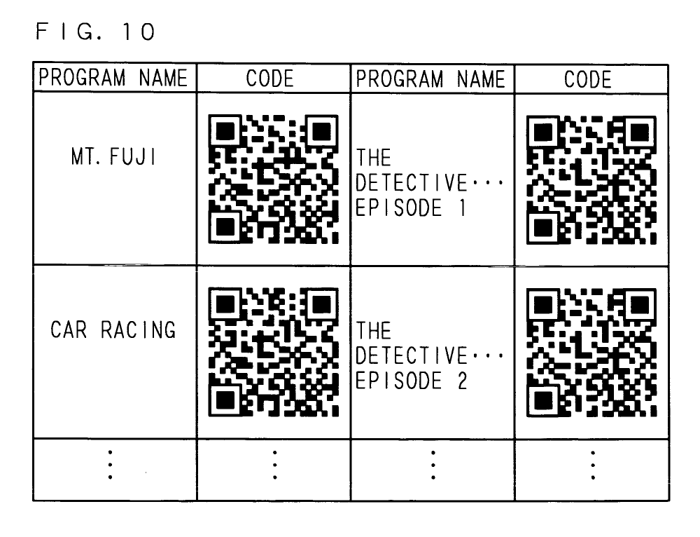

The user picks up the image of a desired bar code in the program name list sheet as shown in FIG. 10 by the digital camera 2, with the name set screen shown in FIG. 9A displayed on the monitor device 38a connected to the recording and reproducing apparatus 3. The bar code in this program name list sheet is obtained by coding a program name of a broadcast program which has been broadcast or is on air. Accordingly, the user uses such a bar code, when adding the file name or folder name to the broadcast program recorded by the recording and reproducing apparatus 3. The digital camera 2 inputs the image data acquired by the camera unit 13a in the code extraction unit 20, when the name button 18c is turned on and the shutter button 18d is turned on by the user.

In addition, the code extraction unit 20 detects whether or not there is the code in the acquired image data, and when the code is detected in the image data, acquires the detected code from the image data and inputs it in the decoder selection unit 21 and the decoding unit 22. Further, the decoder selection unit 21 selects the proper decoder based on the code inputted from the code extraction unit 20, and the decoding unit 22 decodes the code inputted from the code extraction unit 20 by the decoder selected by the decoder selection unit 21. The CPU 10 displays on the display unit 16 the code information obtained by decoding the code by the decoder 22.

The user determines whether or not the code information displayed on the display unit 16 of the digital camera 2 is desired, and when it is desired, operates the transmission button 18f of the operation unit 18. Thus, the CPU 10 of the digital camera 2 transmits the code information displayed on the display unit 16 to the recording and reproducing apparatus 3 from the communication interface 23.

Meanwhile, in the recording and reproducing apparatus 3 that receives the code information from the digital camera 2, the CPU 30 sends the received code information to the monitor device 38a from the connection unit 38, to display it on a name box of the name set screen. Here, the user determines whether or not the file name (code information) displayed in the name set screen is desired, and when it is desired, operates the determination button 41 of the remote controller 40, and when it is not desired, operates the return button 42.

When the user operates the determination button 41, the CPU 30 of the recording and reproducing apparatus 3 causes the DVD recorder 36 to store the file name (code information) displayed in the name box of the name set screen, as the file name of the image file selected by the user. Thus, the arbitrary file name such as “Mt. Fuji” in FIG. 9A can be given. In addition, when the folder is selected in FIG. 9A, the code information acquired by the digital camera 1 becomes the folder name of the selected folder, and when the file is selected, the code information acquired by the digital camera 1 becomes the file name of the selected file.

Here, when the code cannot be detected in the image data acquired by the camera unit 13a for generating the folder name or file name, the code extraction unit 20 of the digital camera 2 reports accordingly to the CPU 10. The CPU 10 cannot detect the code from the image data obtained by picking up the image, following the report from the code extraction unit 20, displays on the display unit 16 the message that the arbitrary folder name or file name cannot be given, and reports accordingly to the user.

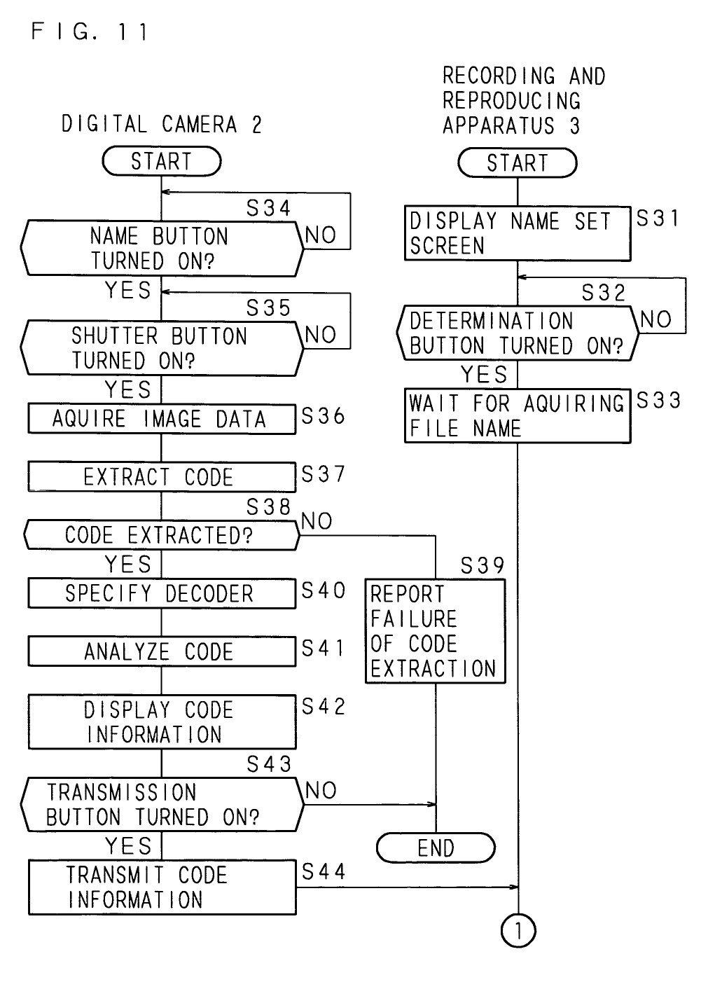

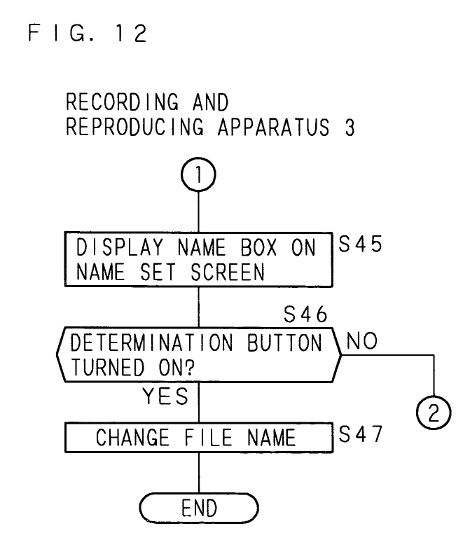

In the data storage system having the above-described structure, the generation processing of the folder name or file name relating to the image file of each broadcast program recorded in the DVD recorder 36 of the recording and reproducing apparatus 3 will be explained hereunder. FIG. 11 and FIG. 12 show flowcharts showing the generation processing procedure of the folder name or file name by the digital camera 2 according to the embodiment 2.

In the recording and reproducing apparatus 3, when the file name or folder name of the image file recorded in the DVD recorder 36 is changed, the user operates the predetermined operation button of the remote controller 40 or the predetermined operation button of the operation unit 33, and displays the name set screen shown in FIG. 9A on the monitor device 38a. When the predetermined operation button is operated by the user, the CPU 30 of the recording and reproducing apparatus 3 reads predetermined screen information from the ROM 31, and displays the name set screen on the monitor device 38a (S31). The user operates the cursor key 40 and selects the image file whose name is desired to be changed, from the image file displayed in the name set screen. Also, the user operates the determination button 41 and determines a desired image file.

The CPU 30 determines whether or not the determination button 41 is turned on (S32), and when determining that the determination button 41 is not turned on (S32: NO), continues the display of the name set screen (S31), and changes the image file to be selected, following the cursor key 40 operated by the user. When determining that the determination button 41 is turned on (S32: YES), the CPU 30 displays the name box in the name set screen as shown in FIG. 9B, and becomes in a waiting state of acquiring the file name (folder name) (S33).

Meanwhile, in this state, the user turns on the name button 18c of the digital camera 2 for changing the file name of the image file selected in the name set screen. In the digital camera 2, the CPU 10 determines whether or not the name button 18c of the operation unit 18 is turned on (S34), and when determining that the name button 18c is not turned on (S34: NO), stands by until the name button 18c is turned on, and when determining that the name button 18c is turned on (S34: YES), determines whether or not the shutter button 18d is turned on by the user (S35).

The user turns on the shutter button 18d for picking up the image of a desired code in the program name list sheet as shown in FIG. 10 by the camera unit 13a, and when determining that the shutter button 18d is not turned on (S35: NO), the CPU 10 stands by until the shutter button 18d is turned on. When determining that the shutter button 18d is turned on (S35: YES), the CPU 10 fetches the image data acquired by the camera unit 13a, i.e. the image data obtained by picking up the image of the desired code here (S36), and inputs in the code extraction unit 20 the image data outputted from the camera processing unit 13.

The code extraction unit 20 extracts the code from the image data inputted from the camera processing unit 13 (S37), and inputs the code thus extracted in the decoder selection unit 21 and the decoding unit 22. Meanwhile, when the code cannot be detected in the image data, the code extraction unit 20 reports accordingly to the CPU 10, and by this report, the CPU 10 determines whether or not the code can be extracted by the code extraction unit 20 (S38). When determining that the code cannot be extracted (S38: NO), the CPU 10 causes the display unit 16 to display the message that the code cannot be extracted from the image data obtained by picking up the image and the arbitrary file name cannot be generated, then this message is reported (S39) and the processing is terminated.

Meanwhile, when determining that the code can be extracted (S38: YES), the decoder selection unit 21 specifies a corresponding decoder based on the code inputted from the code extraction unit 20 (S40), and the decoding unit 22 analyzes the code inputted from the code extraction unit 20 by the decoder selected by the decoder selection unit 21 (S41). The CPU 10 causes the display unit 16 to display the code information thus obtained by analyzing the code by the decoding unit 22 (S42), and determines whether or not the transmission button 18f is turned on by the user (S43).

VVhen determining that the transmission button 18f is turned on (S43: YES), the CPU 10 transmits the code information displayed on the display unit 16 to the recording and reproducing apparatus 3 from the communication interface 23 (S44), and when determining that the transmission button 18f is not turned on (S43: NO), the processing is terminated when a cancel button not shown, for example, is turned on. Note that the CPU 10 causes the recording medium 17 to record the code extracted in step S37 and the code information acquired by analyzing the code in step S41, for each corresponding decoder.

In the recording and reproducing apparatus 3 that receives the code information from the digital camera 2, the CPU 30 displays the received code information in the name box of the name set screen as shown in FIG. 9B (S45), and determines whether or not the determination button 41 of the remote controller 4 is turned on by the user (S46). When determining that the determination button 41 is turned on by the user (S46: YES), the CPU 30 changes the file name of the image file selected in step S32 (S47). In addition, when the folder is selected in step S32, the folder name of the selected folder is changed.

Meanwhile, when the CPU 30 determines that the determination button 41 is not turned on by the user (S46: NO), that is, when the return button 42 is turned on, the display of the name box of the name set screen is canceled and the processing is returned to step S33, and the CPU 10 becomes in the waiting state of acquiring the file name again (S33).

As described above, in this embodiment 2, based on the code information acquired by analyzing the code whose image is picked up by the camera unit 13a of the digital camera 2, the arbitrary folder name or file name can be given to the image file of the broadcast program recorded in the recording and reproducing apparatus 3. Therefore, it is not necessary to previously prepare the code information DB 14b as shown in the embodiment 1.

In the above-described embodiment 2, explanation is given to the structure of transmitting to the recording and reproducing apparatus 3 the code information acquired by analyzing the bar code, whose image is picked up by the digital camera 2. However, when the camera unit is provided in the remote controller 40, the digital camera 2 is not required to be used, and based on the code information generated from the image data, whose image is picked up by the remote controller 40 capable of remotely controlling the recording and reproducing apparatus 3 from a distance, the folder name and the file name of the image file recorded in the recording and reproducing apparatus 3 can be generated.

Also, in the above-described embodiment, an explanation is given to the structure of providing the plurality of decoders and analyzing the code extracted from the image data obtained by picking up the image, by a different decoder in accordance with the kind of the code. However, in the device only necessary to analyze one kind of code, it is sufficient to provide one decoder. In addition, in this embodiment 2 also, application of the modified example similar to the modified example explained in the above-described embodiment 1 is possible.

### EMBODIMENT 3

The information processing system according to the present invention will be explained in detail hereunder, based on the drawings showing an embodiment 3. The information processing system of this embodiment 3 is composed of the digital camera 2 (see FIG. 7) as the information transmitter of the present invention, and the recording and reproducing apparatus 3 (see FIG. 8) as the information processor of the present invention. The information processing system of the present invention can be realized by the same structure as that of the above-described data storage system of the embodiment 2, and is composed of the digital camera 2 and the recording and reproducing apparatus 3 of the embodiment 2, and therefore the explanation is omitted.

In the information processing system of this embodiment 3, the recording and reproducing apparatus 3 records in the DVD recorder 36 each broadcast program received by the tuner 35 as the image file. In addition, the recording and reproducing apparatus 3 is constituted, so that a reservation recording processing of the broadcast program is also possible in the DVD recorder 36, and when reservation information such as the broadcast channel, a recording start time and a recording termination time, etc, of the broadcast program are inputted by the user, the reservation information thus required is stored in the RAM 32. Thereafter, when the recording start time shown by the reservation information is elapsed, the recording and reproducing apparatus 3 starts a recording processing of the broadcasting signal corresponding to the broadcast channel already set, and when the recording termination time is elapsed, terminates the recording processing.

Here, in the information processing system of this embodiment 3, the digital camera 2 picks up the image of the bar code obtained by coding the aforementioned reservation information, analyzes the image data thus obtained and acquires the code information (reservation information), and transmits the code information thus obtained to the recording and reproducing apparatus 3 by wireless communication. The recording and reproducing apparatus 3 that receives the code information from the digital camera 2 stores the code information thus received in the is RAM 32, and becomes in a waiting state of starting the recording processing. Thus, the reservation of the recording processing by the recording and reproducing apparatus 3 can be performed by the bar code, thus eliminating a complicated key operation by the user.

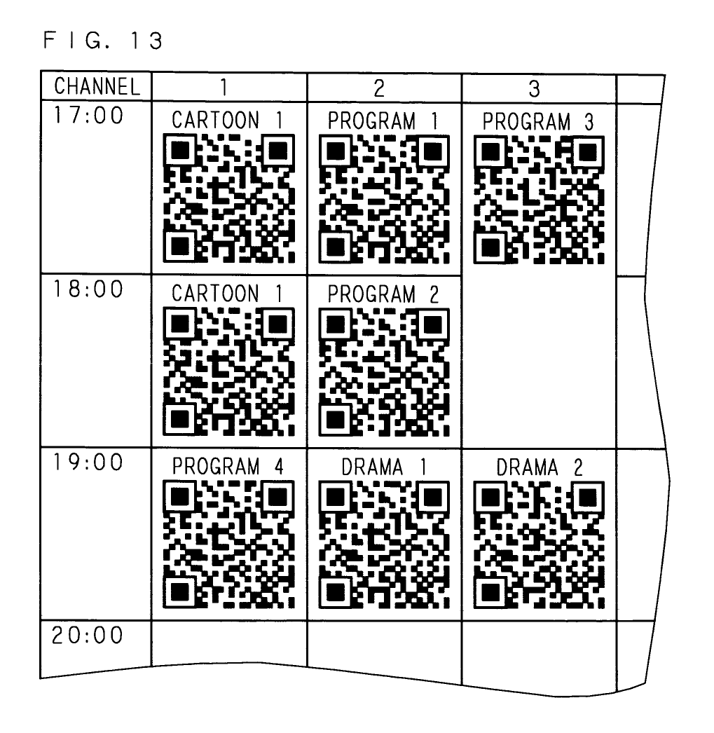

Specifically, the digital camera 2 of this embodiment 3 picks up the image of each bar code in the broadcast program list sheet as shown in FIG. 13. The bar code in the broadcast program list sheet is obtained by coding the broadcast channel and the broadcasting start time and the broadcasting termination time in each broadcast program. Accordingly, the user uses the bar code when the record of the broadcast program is reserved by the recording and reproducing apparatus 3. Also, the digital camera 2 has an “information fetching” button (not shown) instead of the name button 18c, and when the information fetching button is turned on by the user, the digital camera 2 extracts the code from the image data, whose image is picked up by the camera unit 13a, and executes the processing of fetching the code information by analyzing the code thus extracted.

Next, the digital camera 2 extracts the code by the code extraction unit 20 from the image data obtained by picking up the image of the bar code in the broadcast program list sheet by the camera unit 13a, and inputs the extracted code in the decoder selection unit 21 and the decoding unit 22. In addition, the digital camera 2 decodes the code extracted by the code extraction unit 20 by the proper decoder selected by the decode selection unit 21, and displays the code information thus acquired on the display unit 16.

According to this embodiment 3, in the digital camera 2, for example, the code information (reservation information) of “channel: 1, cartoon 1 at broadcasting time of 17:00 to 18:00” is displayed on the display unit 16, and when the transmission button 18f is turned on by the user, the code information displayed on the display unit 16 is transmitted to the recording and reproducing apparatus 3 from the communication interface 23. The recording and reproducing apparatus 3 receives the code information from the digital camera 2 by the communication interface (communication unit, reception means) 37, and the CPU 30 displays on the monitor device 38a the reservation information shown by the code information thus received, specifically, a reservation information confirmation screen displaying the message that the reservation of “channel: 1, cartoon 1 at broadcasting time of 17:00 to 18:00” is received, and reports this message to the user.

The user determines whether or not this message is desired reservation recording information, following the reservation information confirmation screen displayed on the monitor device 38a, and when it is desired, operates the determination button 41 of the remote controller 40, and when it is not desired, operates the return button 42. When the user operates the determination button 41, the CPU 30 of the recording and reproducing apparatus 3 stores the reservation information thus displayed in the RAM 32, and functions as a processing means that performs the reservation of the recording processing of the broadcast program to the DVD recorder 36.

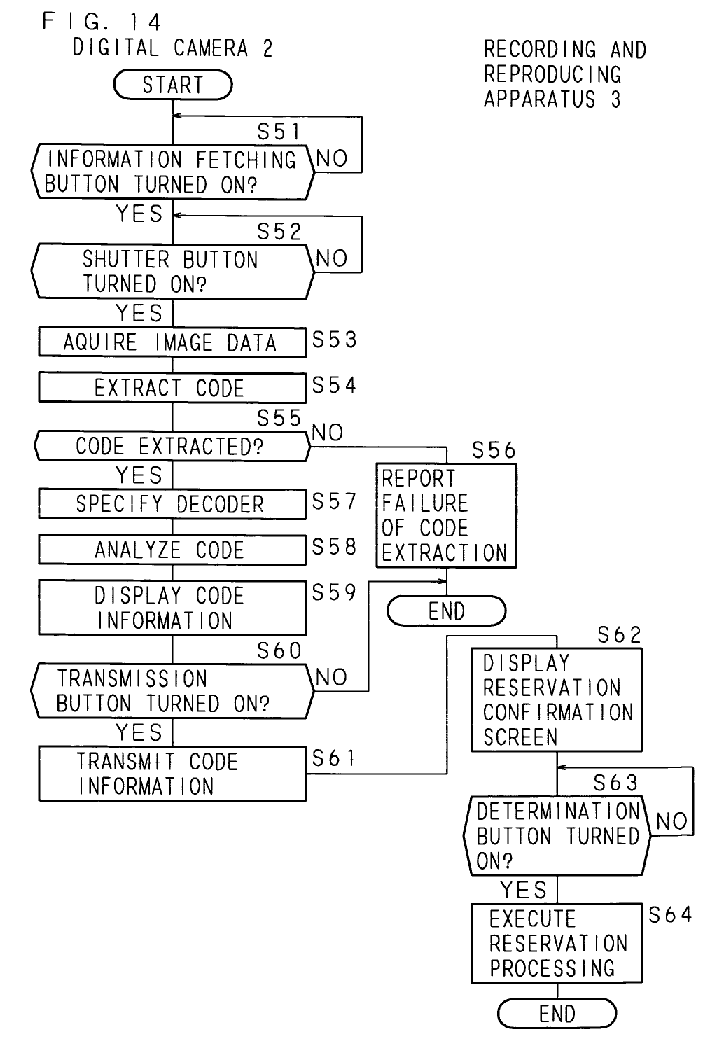

In the information processing system having the above-described structure, hereunder, the explanation will be given to the reservation recording processing of the broadcast program performed to the DVD recorder 36 of the recording and reproducing apparatus 3. FIG. 14 is a flowchart showing the reservation recording processing procedure performed to the recording and reproducing apparatus 3 by the digital camera 2 according to the embodiment 3.

In the recording and reproducing apparatus 3, when the reservation recording processing is desired to be performed to the DVD recorder 36, the user turns on the information fetching button of the digital camera 2. In the digital camera 2, the CPU 10 determines whether or not the information fetching button is turned on (S51), and when determining that the information fetching button is not turned on (S51: NO), the CPU 10 stands by until it is turned on. When determining that the information fetching button is turned on (S51: YES), the CPU 10 determines whether or not the shutter button 18d is turned on by the user (S52).

The user selects a desired code from the broadcast program list sheet as shown in FIG. 13, and turns on the shutter button 18d to pick up the image of the desired code by the camera unit 13a. When determining that the shutter button 18d is not turned on by the user (S52: NO), the CPU 10 stands by until the shutter button 18d is turned on. When determining that the shutter button 18d is turned on (S52: YES), the CPU 10 fetches the image data obtained by picking up the image by the camera 13a (S53), and extracts the code from the image data acquired from the camera processing unit 13 by the code extraction unit 20 (S54).

When the code is extracted from the image data, the code extraction unit 20 inputs the extracted code in the decoder selection unit 21 and the decoding unit 22, and when the code cannot be extracted from the image data, reports accordingly to the CPU 10. By this report, the CPU 10 determines whether or not the code can be extracted by the code extraction unit 20 (S55), and when determining that the code cannot be extracted (S55: NO), displays the message on the display unit 16 that the code cannot be extracted from image data, whose image is picked up, reports accordingly (S56), and terminates the processing.

Meanwhile, when the CPU 10 determines that the code can be extracted (S55: YES), the decoder selection unit 21 specifies the corresponding decoder based on the code inputted from the code extraction unit 20 (S57), and the decoding unit 22 analyzes the code thus inputted from the code extraction unit 20 by the decoder selected by the decoder selection unit 21 (S58).

The CPU 10 displays on the display unit 16 the code information obtained by analyzing the code by the decoding unit 22, i.e. the reservation information of the recording processing by the recording and reproducing apparatus 3, here, (S59), and determines whether or not the transmission button 18f is turned on by the user (S60). When determining that the transmission button 18f is turned on (S60: YES), the CPU 10 transmits the code information displayed on the display unit 16 to the recording and reproducing apparatus 3 from the communication interface 23 (S61), and when determining that the transmission button 18f is not turned on (S60: NO), for example, when the cancel button not shown is turned on, the CPU 10 terminates the processing.

In the recording and reproducing apparatus 3 that receives the code information from the digital camera 2, the CPU 30 displays on the monitor unit 38a the reservation information confirmation screen, in which the received code information is displayed (S62), and determines whether or not the determination button 41 of the remote controller 4 is turned on by the user (S63). When determining that the determination button 41 is turned on by the user (S63: YES), the CPU 30 stores the code information received from the digital camera 2 in the RAM 32 and executes the reservation processing (S64).

Meanwhile, when determining that the determination button 41 is not turned on by the user (S63: NO), that is, when the return button 42 is turned on, the CPU 30 terminates the processing. The user picks up the image of the code in the broadcast program list sheet again by the digital camera 2.

As described above, in this embodiment 3, based on the code information acquired by analyzing the code whose image is picked up by the camera unit 13a of the digital camera 2, the reservation of the recording processing by the recording and reproducing apparatus 3 can be performed. Note that in this embodiment 3 also, the application of the modified example similar to the modified example explained in the aforementioned embodiments 1 and 2 is possible.

### EMBODIMENT 4

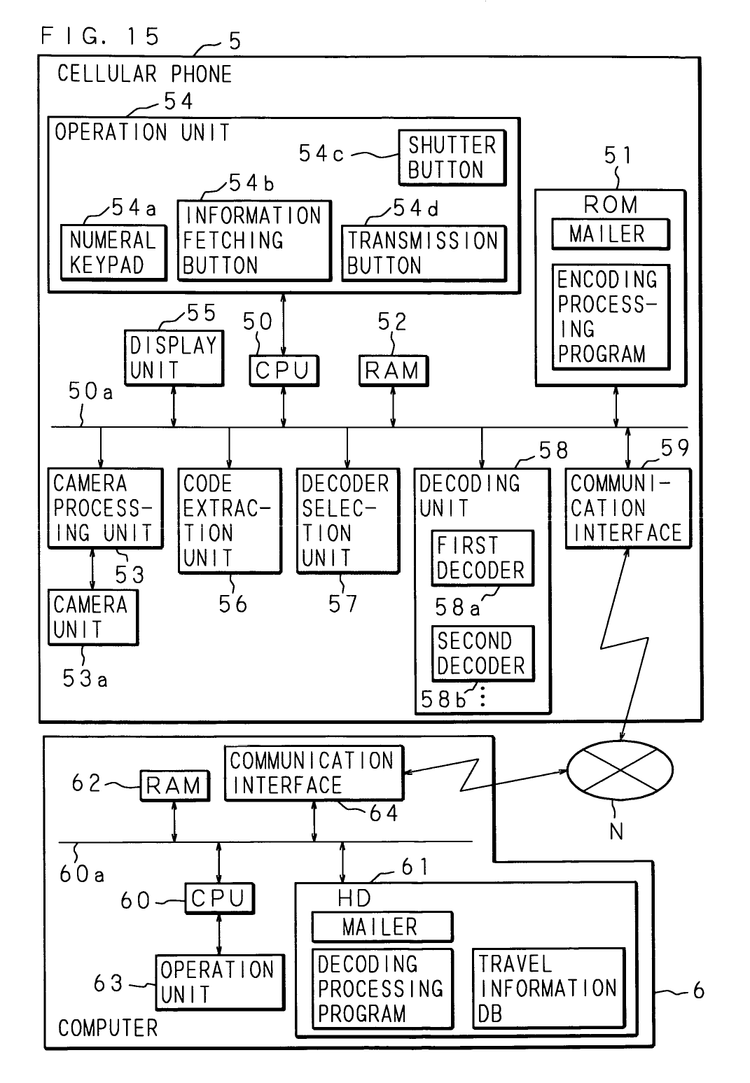

The information processing system according to the present invention will be explained in detail hereunder, based on the drawings shown in an embodiment 4. FIG. 15 is a block diagram showing an exemplary constitution of a cellular phone 5 and a computer 6 in the information processing system according to the present invention. The information processing system of this embodiment 4 is composed of the cellular phone 5 as the information transmitter of the present invention, and the computer 6 as the information processor of the present invention, each being capable of communicated to each other through network N such as Internet.

In the information processing system of this embodiment 4, the computer 6 receives an application of travel, functions as a server device managing the information of each customer thus received, and receives the application of travel by e-mail via network N. Also, the cellular phone 5 of this embodiment 4 picks up the image of the bar code obtained by coding the information on each travel, acquires the code information (information on travel) by analyzing the image data thus obtained, and prepares e-mail based on the code information thus obtained and transmits it to the computer 6.

The computer 6 that receives the e-mail from the cellular phone 5 updates travel information DB of HD61, based on the e-mail thus received. Thus, when applying for travel, the user of the cellular phone 5 can input the information on applied travel by the bar code, without operating the operation unit 54 of the cellular phone 5, thus eliminating a complicated key operation by the user.

The internal constitutional example of the cellular phone 5 and the computer 6 constituting the information processing system of this embodiment 4 will be explained hereunder. As shown in FIG. 15, the cellular phone 5 of the embodiment 4 comprises a CPU 50, a ROM 51, a RAM 52, a camera processing unit 53, a display unit 55, a code extraction unit 56, a decoder selection unit 57, a decoding unit 58, and a communication interface 59 for communicating with an external device via network N, each mutually being connected via a bus 50a.

The CPU 50 functions as the control center of the cellular phone 5, controls each unit of the aforementioned hardware connected with one another via the bus 50a, and realizes various software-based functions, following the control programs previously stored in the ROM 51. The ROM 51 stores various control programs required for operating the cellular phone 5 as the information transmitter of the present invention, a mailer for performing transmission/reception of e-mail with the external device via network N, and encoding processing programs, and so forth. The RAM 52 is composed of the SRAM or the flash memory, etc, and temporarily stores the data generated during executing the control programs by the CPU 50. In addition, the CPU 50 functions as an encoding means, by reading in the RAM 52 the encoding processing programs stored in the ROM 51, and sequentially executing them, and encodes each kind of data as needed.

The camera processing unit 53 is connected to the camera unit 53a serving as the image pickup unit composed of CCD or the like, and picks up the image by the camera unit 53a at a timing following the control of the CPU 50, thereby fetching the image data, and after the image data thus obtained being subjected to a predetermined processing, inputs the image data in the display unit 55 via the bus 50a and displays it on the display unit 55. In addition, the camera processing unit 53 inputs the image data acquired by following the control from the CPU 50, in the code extraction unit 56.

The display unit 55 is composed of a liquid crystal display (LCD), and displays an operation state of the cellular phone 5, the information to be reported to the user, and the image data obtained by picking up the image by the camera unit 53a, and so forth. In addition, by forming the display unit 55 in a touch-panel type, a unit or the whole unit of each kind of keys of the operation unit 54 can be substituted.

The CPU 50 is connected to the operation unit 54. The operation unit 54 is equipped with various kind of keys required for operating the cellular phone 5 by the user, specifically, such as a numeral key pad 54a, an information fetching button 54b, a shutter button 54c, and a transmission button 54d, etc. The information fetching button 54b is the button used for reading the predetermined information from the image data obtained by picking up the image by the camera unit 53a. The shutter button 54c is the button for giving an instruction as to the timing for fetching the image data as a static image from the image data sequentially acquired by the camera unit 13a. The transmission button 54d is the button for giving an instruction to transmit e-mail. In addition, when the user operates each key, the operation unit 54 sends to the CPU 50 the control signal corresponding to an operated key, and the CPU 50 executes the processing corresponding to the control signal thus acquired.

The code extraction unit 56 detects whether or not the code previously coded by a predetermined processing is included in the image data inputted from the camera processing unit 53, and when the code is detected in the image data, functions as the code acquisition means that acquires the detected code, and transmits the code acquired from the image data to the decoder selection unit 57 and a decoding unit 58.

The cellular phone 5 of this embodiment 4 has a plurality of the decoders of first decoder 58a, a second decoder 58b . . . in the decoding unit 58, as the analyzing means that analyzes the code extracted by the code extraction unit 56 and acquires the code information. The decoder selection unit 57 functions as a selection means that selects the decoder capable of analyzing the code based on the code transmitted from the code extraction unit 56, and the CPU 50 causes the decoder selected by the decoder selection unit 57 to analyzes the code extracted by the code extraction unit 56.

The communication interface 59 functions as a transmitter that transmits to the external device the code information obtained by analyzing the code by the proper decoder of the decoding unit 58, the code being extracted from the image data acquired by the camera unit 53a. In addition, as described above, the CPU 50 displays the code information decoded by the proper decoder on the display unit (display means) 55, and based on whether or not the code information thus displayed is properly decoded, the user inputs the instruction whether or not the displayed code information is transmitted to the computer 6, by operating the transmission button 54d of the operation unit 54.

The CPU 50 functions as an instruction reception means that receives the instruction as to whether or not the code information displayed on the display unit 55 is to be transmitted to the computer 6, based on whether or not the transmission button 54d is operated by the user. When the transmission button 54d is operated by the user, the CPU 50 reads in the RAM 52 the encoding processing program of ROM 51, and performs the encoding processing to the code information displayed on the display unit 55. In addition, the CPU 50 prepares e-mail, with the encoding information as a main body, and transmits it to a predetermined device from the communication interface 59 via network N.

Meanwhile, as shown in FIG. 15, the computer 6 has a CPU 60, a hard disk (referred to as HD hereafter) 61, a RAM 62, and a communication interface 64 for communicating with the external device via network N, and so forth, each mutually being connected via a bus 60a.

The CPU 60 functions as the control center of the computer 6, and controls each unit of the aforementioned hardware connected via the bus 60a, and realizes various software-based functions, following the control programs previously stored in the HD 61. The HD 61 previously stores various kind of control programs required for operating the computer 6 as the information processor of the present invention, the mailer for performing the transmission/reception of the e-mail with the external device via network N, decoding processing programs for decoding the encoding information encoded in the cellular phone 5, and a travel information database that manages the information on each kind of travel (referred to as travel information DB hereafter). The RAM 62 is composed of the SRAM or flash memory, etc, and temporarily stores the data generated during executing the control programs by the CPU 60.

The CPU 60 is connected to the operation unit 63 composed of a keyboard and a mouse. When the user operates each key of the operation unit 63, the operation unit 63 sends the control signal corresponding to the operated key to the CPU 60, and the CPU 60 executes the processing corresponding to the control signal thus acquired.

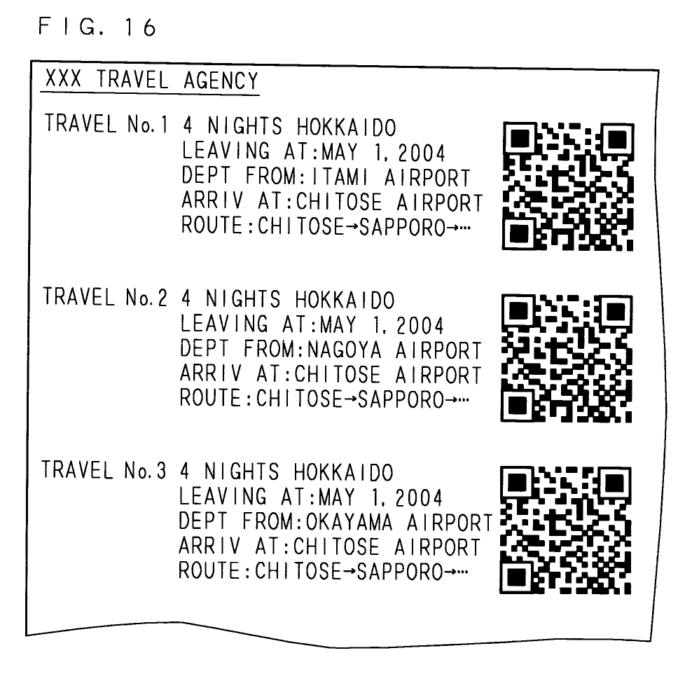

In the information processing system comprising the cellular phone 5 and the computer 6 having the above-described structure, the cellular phone 5 picks up the image of each bar code in the travel list sheet as shown in FIG. 16 by the camera unit 53a. The bar code in the travel list sheet is obtained by coding the information on each travel and e-mail address showing an agent for the travel. Accordingly, the user uses the bar code when reserving the travel in the travel list sheet shown in FIG. 16.

Specifically, the user turns on the information fetching button 54b of the operation unit 54 of the cellular phone 5, and picks up the image of the bar code in the travel list sheet shown in FIG. 16 by the camera unit 53a. In the cellular phone 5, when the information fetching button 54b is turned on and the shutter button 54c is turned on by the user, the image data acquired by the camera unit 53a is inputted in the code extraction unit 56.

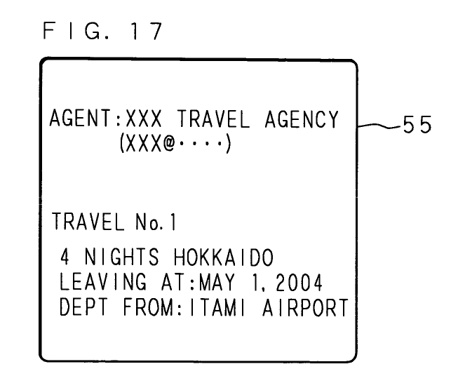

The code extraction unit 56 detects whether or not there is the code in the acquired image data, and when the code is detected in the image data, extracts the detected code from the image data and inputs it in the decoder selection unit 57 and the decoding unit 58. In addition, the decoder selection unit 57 selects the proper decoder based on the code inputted from the code extraction unit 56, and decodes the code inputted from the code extraction unit 56 by the decoder selected by the decoder selection unit 57. The CPU 50 displays the code information decoded and obtained by the decoding unit 58 on the display unit 55 as a user confirmation screen as shown in FIG. 17.

FIG. 17 is a schematic view showing an exemplary constitution of the user confirmation screen. Following the user confirmation screen displayed on the display unit 55 of the cellular phone 5, the user determines whether or not the code information thus displayed is desired, and when it is desired, operates the transmission button 54d of the operation unit 54. Thus, the CPU 50 of the cellular phone 5 encodes the information on the travel in the code information displayed on the display unit 55 as a main body, and prepares the e-mail, with e-mail address in the acquired code information as a transmission destination, and transmits the e-mail thus prepared to a predetermined transmission destination from the communication interface 59.

Meanwhile, the computer 6 receives the e-mail transmitted from the cellular phone 5 by the communication interface (reception means) 64, and the CPU 60 reads in the RAM 62 the decoding processing programs of the HD 61, and executes them, thereby decoding the encoded main body of the received e-mail, and receives a predetermined reservation for travel, following the information thus decoded. Thus, by encoding and sending the transmitted e-mail, high safety against a leak and loss of individual information can be maintained.

Moreover, when the code cannot be detected in the image data acquired by the camera unit 53a, the code extraction unit 56 of the cellular phone 5 reports accordingly to the CPU 50. Following the report from the code extraction unit 56, the CPU 50 displays on the display unit 55 the message that the code cannot be detected from the image data, whose image is picked up and an acquisition of travel information fails, and reports this message to the user.

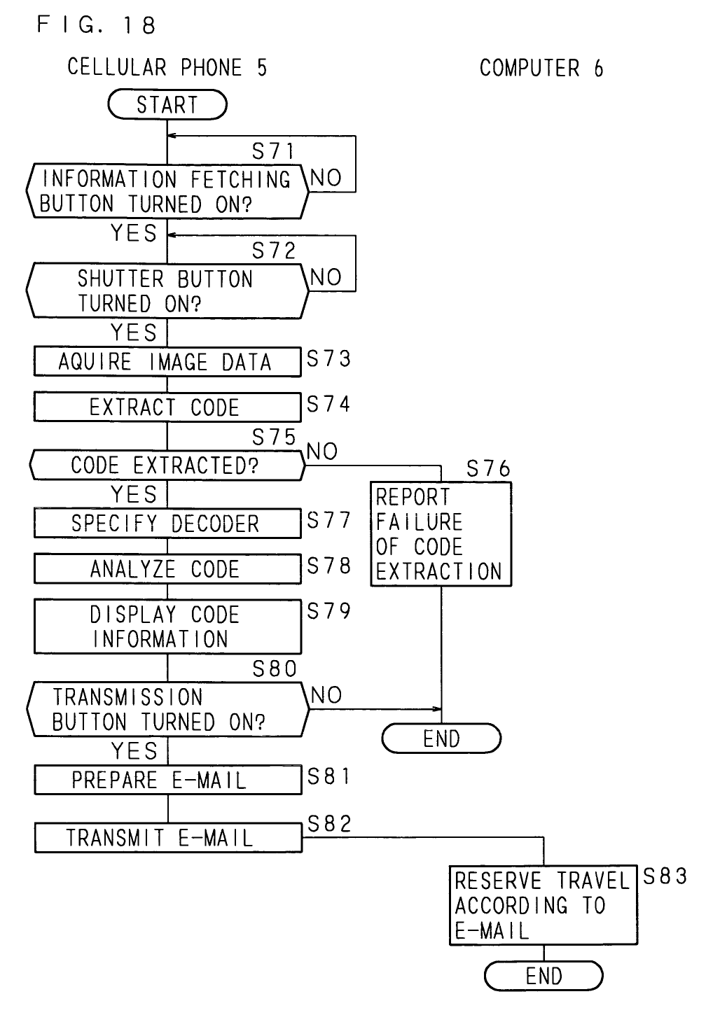

The processing of performing the reservation for travel by using the information processing system having the above-described structure will be explained hereunder. FIG. 18 is a flowchart showing an application processing procedure of travel by the cellular phone 5 according to this embodiment 4.

In the cellular phone 5, when the user desires to reserve the travel by choosing from the travel list sheet as shown in FIG. 16, the user turns on the information fetching button 54b of the cellular phone 5. In the cellular phone 5, the CPU 50 determines whether or not the information fetching button 54b is turned on (S71), and when determining that the information fetching button 54b is not turned on (S71: NO), the CPU 50 stands by until it is turned on. When determining that the information fetching button 54b is turned on (S71: YES), the CPU 50 determines whether or not the shutter button 54c is turned on by the user (S72).

The user selects desired travel from the travel list sheet shown in FIG. 16, and turns on the shutter button 54c for picking up the image of the code corresponding to the desired travel by the camera unit 53a. When determining that the shutter button 54c is not turned on (S72: NO), the CPU 50 stands by until the shutter button 54c is turned on, and when determining that the shutter button 54c is turned on (S72: YES), fetches the image data obtained by picking up the image by the camera unit 53a (S73), and the code extraction unit 56 extracts the code from the image data outputted from the camera processing unit 53 (S74). When the code is extracted from the image data, the code extraction unit 56 inputs the extracted code in the decoder selection unit 57 and the decoding unit 58, and when the code is not extracted from the image data, reports accordingly to the CPU 50.

The CPU 50 determines whether or not the code can be extracted by the code extraction unit 56 by this report (S75), and when determining that the code cannot be extracted (S75: NO), displays the message on the display unit 55 that the code cannot be extracted from the image data, whose image is picked up, and reports this message to the user (S76), and terminates the processing.

Meanwhile, when determining that the code can be extracted (S75: YES), the decoder selection unit 57 specifies the corresponding decoder based on the code inputted from the code extraction unit 56 (S77), and the decoding unit 58 analyzes the code inputted from the code extraction unit 56 by the decoder selected by the decoder selection unit 57 (S78). The CPU 50 displays, on the display unit 55, the code information obtained by analyzing the code by the decoding unit 58, i.e. the user confirmation screen showing travel information as shown in the travel list sheet here (S79), and determines whether or not the transmission button 54d is turned on by the user (S80).

When determining that the transmission button 54d is turned on (S80: YES), the CPU 50 encodes the information on the travel in the code information displayed on the display unit 55, defining it as the main body, prepares the e-mail, with the e-mail address in the acquired code information as the transmission destination (S81), and transmits the e-mail thus prepared to a predetermined transmission destination from the communication interface 59 (S82). Note that when determining that the transmission button 54d is not turned on (S80: NO), for example, when the cancel button not shown is turned on, the processing is terminated.

In a computer 6 that receives the e-mail from the cellular phone 5, the CPU 60 decodes the encoded main body of the received e-mail, and performs a predetermined reservation of travel, following the decoded information (S83). Specifically, the e-mail address of a transmission source of the received e-mail and name and address, etc, inputted by a transmitting unity are registered in the travel information DB of the HD61.

As described above, in this embodiment 4, based on the code information acquired by analyzing the code, whose image is picked up by the camera unit 53a of the cellular phone 5, the travel can be reserved.

Further, in the information processing system of the present invention, not only the travel, but various tickets, for example, can also be reserved. In addition, in the same way as the data storage system of the aforementioned embodiment 2 and the digital camera 2 of the information processing system of the embodiment 3, the cellular phone 5 in the information processing system of the aforementioned embodiment 4 also has the recording medium. Then, by storing the code extracted from the image data obtained by picking up the image and the code information obtained by decoding each code by the proper decoder, for each corresponding decoder, it is not necessary for the code already analyzed once to be subjected to re-analyzing processing, thus reducing a processing load. Also, in this embodiment 4 also, the application of the modified example similar to the modified example explained in the aforementioned embodiments 1 and 2 is possible.

1. A data storage device having a storage means for storing acquired data in a hierarchical structure, comprising:
an image pickup unit;
an extraction means for extracting a piece of code information from a piece of image data acquired by picking up an image by the image pickup unit; and
a name generation means for generating a folder name or a file name relating to the piece of image data based on the piece of code information extracted by the extraction means.

2. A data storage device having a storage means for storing acquired data in a hierarchical structure, comprising:
an image pickup unit;
a code recognition unit having a table in which pieces of code information is respectively corresponded to a plurality of pieces of image data;
an extraction means for extracting a piece of the code information, from the table, corresponding to a piece of the image data acquired by picking up an image by the image pickup unit; and
a name generation means for generating a folder name or a file name relating to the piece of the image data based on the piece of the code information extracted by the extraction means.

3. The data storage device according to claim 1, further comprising a determination means for determining whether or not the piece of the code information is extracted by the extraction means, wherein when the determination means determines that the piece of the code information is not extracted by the extraction means, the name generation means generates the folder name or the file name relating to the piece of the image data based on predetermined information.

4. The data storage device according to claim 3, further comprising a report means for reporting a message that the piece of the code information is not extracted by the extraction means, when the determination means determines accordingly.

5. The data storage device according to claim 1, further comprising:
a folder generation means for generating in the storage means a folder of the folder name generated by the name generation means; and
a name changing means for changing the folder name or the file name relating to data stored in the storage means, to the folder name or the file name generated by the name generation means.

6. The data storage device according to claim 5, further comprising a reception means for receiving a selection of a first or second processing, wherein when the reception means receives the selection of the first processing, the folder generation means generates in the storage means the folder of the folder name generated by the name generation means, and when the reception means receives the selection of the second processing, the name changing means changes the folder name or the file name relating to the data stored in the storage means, to the folder name or the file name generated by the name generation means.

7. An information transmitter that transmits information to outside, comprising:
an image pickup unit;
a code acquisition means for acquiring a code from a piece of image data obtained by picking up an image by the image pickup unit;
an analyzing means for analyzing the code acquired by the code acquisition means and acquires a piece of code information; and
a transmission means for transmitting to outside the piece of code information acquired by the analyzing means.

8. The information transmitter according to claim 7, further comprising:
a display means for displaying the piece of code information acquired by the analyzing means; and
an instruction reception means for receiving an instruction whether or not the piece of code information displayed on the display means is transmitted, wherein
the transmission means transmits the piece of code information when an instruction to transmit the piece of code information is received by the instruction reception means.

9. The information transmitter according to claim 7, further comprising an encoding means for encoding the piece of code information acquired by the analyzing means, wherein the transmission means sends the piece of code information encoded by the encoding means.

10. The information transmitter according to claim 7, further comprising:
a plurality of analyzing means respectively corresponding to different codes; and
a selection means for selecting, based on the code acquired by the code acquisition means, an analyzing means to analyze the code from the plurality of analyzing means, wherein
the analyzing means selected by the selection means analyzes the code acquired by the code acquisition means.

11. The information transmitter according to claim 10, further comprising a storage means for storing the code acquired by the code acquisition means and the piece of code information acquired by analyzing the code by the analyzing means, for each analyzing means selected by the selection means.

12. A data storage system, comprising:
the information transmitter according to claim 7; and
a data storage device for storing data in a hierarchical structure, the data storage device comprising:
a reception means for receiving the piece of code information transmitted from the information transmitter; and
a name generation means for generating a folder name or a file name relating to the data, based on the piece of code information received by the reception means.

13. An information processing system, comprising:
the information transmitter according to claim 7, and
an information processor for performing a predetermined processing based on the piece of code information transmitted from the information transmitter.

14. A data storage device having recording medium that stores acquired data in a hierarchical structure, comprising:
an image pickup unit; and
a controller capable of:
extracting a piece of code information from a piece of image data acquired by picking up an image by the image pickup unit, and
generating a folder name or a file name relating to the piece of image data, based on the piece of code information thus extracted.

15. A data storage device having a recording medium that stores acquired data in a hierarchical structure, comprising:
an image pickup unit;
a code recognition unit having a table in which pieces of code information are respectively corresponded to a plurality of pieces of image data; and
a controller capable of:
extracting a piece of the code information, from the table, corresponding to a piece of the image data acquired by picking up an image by the image pickup unit; and
generating a folder name or a file name relating to the piece of the image data, based on the piece of the code information thus extracted.

16. The data storage device according to claim 14, further comprising a controller capable of:
determining whether or not the piece of code information is extracted; and
generating the folder name or the file name relating to the piece of image data based on predetermined information, when determining that the piece of code information is not extracted.

17. The data storage device according to claim 16, further comprising a controller capable of reporting a message that the piece of code information is not extracted, when determining accordingly.

18. The data storage device according to claim 14, further comprising a controller capable of:
generating in the storage medium a folder of a generated folder name; and
changing the folder name or the file name relating to a piece of image data stored in the storage medium, to the generated folder name or file name.

19. The data storage device according to claim 18, further comprising a controller capable of:
receiving a selection of one of a first processing and a second processing;
generating in the storage medium the folder of the generated folder name, when the selection of the first processing is received, and
changing the folder name or the file name relating to the image data stored in the storage medium, to the generated folder name or the file name, when the selection of the second processing is received.

20. An information transmitter that transmits information to outside, comprising:
an image pickup unit;
a code extraction unit for acquiring a code from a piece of image data obtained by picking up an image by the image pickup unit;
a decoding unit for analyzing the code thus acquired and acquires a piece of code information; and
a communication unit for transmitting the acquired piece of code information to outside.

21. The information transmitter according to claim 20, further comprising:
a display unit for displaying the acquired piece of code information; and
an operation unit for receiving an instruction whether or not the displayed piece of code information is transmitted, wherein
the communication unit transmits the piece of code information when an instruction to transmit the piece of code information is received.

22. The information transmitter according to claim 20, further comprising a controller capable of encoding the acquired piece of code information, wherein
the communication unit transmits the encoded piece of code information.

23. The information transmitter according to claim 20, wherein
the decoding unit includes a plurality of decoders respectively corresponding to different codes, for analyzing the acquired code to acquire the piece of code information, and
the information transmitter further comprises a decoder selection unit for selecting, based on the code acquired by the code extraction unit, a decoder to analyze the code from the plurality of decoders, wherein
the decoder selected by the decoder selection unit analyzes the code acquired by the code extraction unit.

24. The information transmitter according to claim 23, further comprising a controller capable of storing the code acquired by the code extraction unit and the piece of code information obtained by analyzing the acquired code, for each decoder selected by the decoder selection unit.

25. A data storage system, comprising:
the information transmitter according to claim 20; and
a data storage device for storing data in a hierarchical structure, the data storage device comprising:
a communication unit for receiving the piece of code information transmitted from the information transmitter, and
a controller capable of generating a folder name or a file name relating to the data, based on the received piece of code information.

26. An information procesing system, comprising:
the information transmitter according to claim 20; and
an inforamtion processor that performs a predetermined processing based on the piece of code information transmitted from the information transmitter.
